(19) United States
(12) Patent Application Publication
(10) Pub. No.: US 2006/0227985 A1
(43) Pub. Date: Oct. 12, 2006

(54) Information processing apparatus, information processing method, recording medium, and program

(75) Inventor: Kenichiro Kawanami, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/389,267

(22) Filed: Mar. 27, 2006

(30) Foreign Application Priority Data
Apr. 6, 2005 (JP) 2005-110044

(51) Int. Cl. H04R 5/02; H04R 9/06

(52) U.S. Cl. 381/306; 381/333; 381/58

(57) ABSTRACT

Disclosed is an information processing apparatus which performs control to display images. The information processing apparatus includes a display unit which has a display surface to display the images, at least four speakers which are disposed in the periphery of the display surface on the display unit, a rotation detecting unit which detects a 90 degree rotation of the display unit on a predetermined position of the display unit, and a switching unit which switches left and right outputs of a pair of speakers at diagonal positions of the four speakers according to the 90 degree rotation of the display unit detected by the rotation detecting unit.

### CROSS REFERENCES TO RELATED APPLICATIONS

The present invention contains subject matter related to Japanese Patent Application JP 2005-110044 filed in the Japanese Patent Office on Apr. 6, 2005, the entire contents of which being incorporated herein by reference.

### BACKGROUND OF THE INVENTION

1. Field of the Invention

The present invention relates to an information processing apparatus, an information processing method, a recording medium, and a program. In particular, the present invention relates to an information processing apparatus which can provide a comfortable viewing environment to a user without causing any uncomfortable feeling only by switching a pair of left and right sound channels at diagonal positions according to a screen installation direction, even when the screen installation direction is changed, to an information processing method, to a recording medium, and to a program.

2. Description of the Related Art

In general, in display devices using a CRT (Cathode Ray Tube) or an LCD (Liquid Crystal Display), a screen is fixedly disposed in a lateral direction. As disclosed in JP-A-2004-302491, however, there exists a display device which has a screen rotation mechanism in order to enable its longitudinal utilization.

A stereo speaker unit used in such a display device is a split type or a built-in type. In case of the split type, a stereo environment is obtained without being influenced by the rotation of the screen. In case of the built-in type, however, when the screen rotated in a longitudinal direction, the stereo environment could not be obtained.

In JP-A-8-101730, there is suggested a technology which provides a stereo environment to a user by providing a pair of stereo speaker units at diagonal positions of a flat display device capable of standing in longitudinal and lateral directions, even when the standing direction is changed.

Moreover, in JP-A-2002-123333, there is suggested a technology which can switch left and right channels of a stereo speaker unit in a portable information processing apparatus having a screen capable of rotating forward and backward with respect to a computer.

### SUMMARY OF THE INVENTION

In recent years, with the enhancement of video reproducibility due to high resolution, the enhancement of sound reproducibility is demanded. The display device provides the reproduction of a real sound field (stereo environment) by increasing the number of built-in stereo speaker units.

However, in the display device with the increased number of stereo speaker units, as described above, when the display device of a lateral screen rotates by 90 degrees such that the display device can be installed as a longitudinal screen, it is difficult to simply reproduce the real sound field by the increase in the number of stereo speaker units.

It is desirable to simply reproduce a real sound field according to a screen installation direction, even when the number of stereo speaker units is increased.

According to an embodiment of the present invention, there is provided an information processing apparatus which includes a display unit which has a display surface to display the images, at least four speakers which are disposed in the periphery of the display surface on the display unit, a rotation detecting unit which detects a 90 degree rotation of the display unit on a predetermined position of the display unit, and a switching unit which switches left and right outputs of a pair of speakers at diagonal positions of the four speakers according to the 90 degree rotation of the display unit detected by the rotation detecting unit.

The information processing apparatus according to the embodiment of the present invention may further include a support unit which rotatably supports the display unit on the predetermined position of the display unit.

The information processing apparatus according to the embodiment of the present invention may further include an output adjusting unit which adjusts output gains of the four speakers according to the 90 degree rotation of the display unit detected by the rotation detecting unit.

The information processing apparatus according to the embodiment of the present invention may further include a signal receiving unit which receives a broadcast signal, a video rotating unit which rotates a video signal of the broadcast signal received by the signal receiving unit according to the 90 degree rotation of the display unit detected by the rotation detecting unit, and a display control unit which performs control to display a video corresponding to the video signal rotated by the video rotating unit onto the display surface.

The information processing apparatus according to the embodiment of the present invention may further include a video magnifying unit which magnifies the video signal rotated by the video rotating unit according to an image frame of the display unit whose 90 degree rotation is detected by the rotation detecting unit. In this case, the display control unit may perform control to display the video corresponding to the video signal magnified by the video magnifying unit onto the display surface.

The information processing apparatus according to the embodiment of the present invention may further include a transmitting unit which transmits information of the 90 degree rotation of the display unit detected by the rotation detecting unit to another information processing apparatus, and a superimposing unit which superimposes the video signal rotated by the video rotating unit on a video signal from another information processing apparatus. In this case, the display control unit may perform control to display the video corresponding to a superimposed video signal by the superimposing unit onto the display surface.

According to another embodiment of the present invention, there is provided an information processing method which includes the steps of detecting a 90 degree rotation of a display unit having a display surface to display the images on a predetermined position of the display unit, and switching left and right outputs of a pair of speakers at diagonal positions of at least four speakers disposed in the periphery of the display surface on the display unit according to the 90 degree rotation of the display unit detected by a processing at the rotation detecting step.

According to this configuration, the display unit has the display surface to display the images, and at least four speakers are disposed in the periphery of the display surface on the display unit. And then, the 90 degree rotation of the display unit on the predetermined position of the display unit is detected, and the left and right outputs of a pair of speakers at the diagonal positions of at least four speakers disposed in the periphery of the display surface on the display unit are switched according to the detected 90 degree rotation of the display unit.

The information processing apparatus according to the embodiment of the present invention may be a single product. Further, when the information processing apparatus has the display unit and at least four speakers, it can serve as an information processing unit of a broadcast signal receiving apparatus, a personal computer, a cellular phone, other PDA (Personal Digital Assistant) apparatus, a recording and reproducing apparatus, a CE (Consumer Electronics) apparatus, such as an AV (Audio Visual) apparatus or an appliance.

According to the above-described configuration, even when a screen installation direction is changed, a comfortable viewing environment can be simply provided to a user.

### BRIEF DESCRIPTION OF THE DRAWINGS

FIG. 1 is a diagram showing an example of the configuration of a display system to which an embodiment of the present invention is applied;

FIG. 2 is a rear view showing the exterior of a display device shown in FIG. 1;

FIG. 3 is a block diagram showing the internal configuration of the display device shown in FIG. 1;

FIG. 4 is a block diagram showing an example of the detailed configuration of a channel matrix switch and a sound output amplifier shown in FIG. 3;

FIG. 5 is a diagram illustrating processing in the channel matrix switch and the sound output amplifier shown in FIG. 3;

FIG. 6 is a diagram illustrating a processing of a video signal in a video rotating unit shown in FIG. 4;

FIG. 7 is a diagram illustrating a processing of a video signal in the video rotating unit shown in FIG. 4;

FIG. 8 is a block diagram showing an example of the configuration of a personal computer (PC) shown in FIG. 1;

FIG. 9 is a block diagram showing an example of the functional configuration of the PC shown in FIG. 1;

FIG. 10 is a diagram showing a display example of a video to be displayed onto a liquid crystal display (LCD) of a display unit shown in FIG. 1;

FIG. 11 is a flowchart illustrating an example of a screen switching control processing of the display device shown in FIG. 1;

FIG. 12 is a flowchart illustrating an example of a sound signal processing of the display device shown in FIG. 1;

FIG. 13 is a flowchart illustrating an example of a video signal processing of the display device shown in FIG. 1;

FIG. 14 is a diagram showing another display example of a video to be displayed onto the LCD of the display unit shown in FIG. 1;

FIG. 15 is a flowchart illustrating an example of a signal generation processing of the PC shown in FIG. 1;

FIG. 16 is a flowchart illustrating another example of a video signal processing of the display device shown in FIG. 1;

FIG. 17 is a flowchart illustrating still another example of a video signal processing of the display device shown in FIG. 1;

FIG. 18 is a diagram illustrating still another display example of a video to be displayed onto the LCD of the display unit shown in FIG. 1; and

FIG. 19 is a block diagram showing an example of the configuration of a personal computer to which an embodiment of the present invention is applied.

### DESCRIPTION OF THE PREFERRED EMBODIMENTS

Hereinafter, preferred embodiments of the present invention will be described. The relations between the inventions recited in the appended claims and the embodiments are explained in the following description. Even if an embodiment is described in the specification but not described in the following description as what corresponds to an invention, the embodiment is not to be interpreted as an embodiment which does not correspond to the invention. In contrast, even if an embodiment is described in the following description as what corresponds to an invention, the embodiment is not to be interpreted as an embodiment which does not correspond to other inventions than the invention.

Further, the following description is not to be interpreted as a description covering all of the inventions described in the specification. That is, the following description describes the inventions described in the specification, but does not deny inventions not recited in the appended claims of the present application or inventions to be applied by a divisional application or to be added by an amendment in the future.

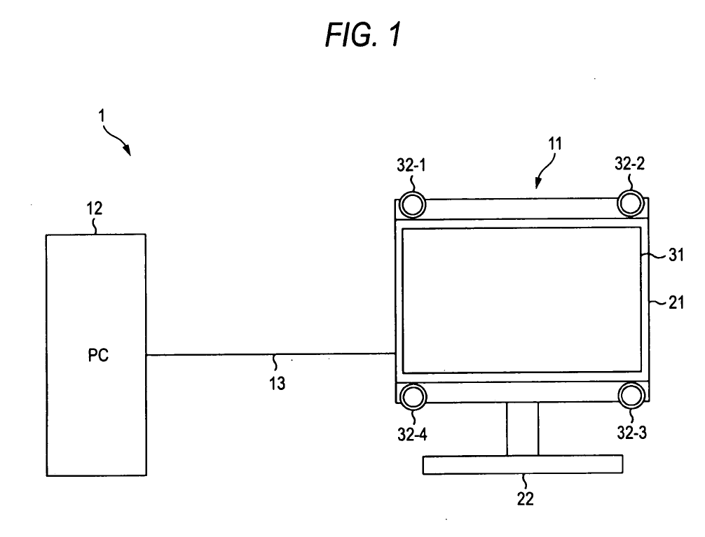

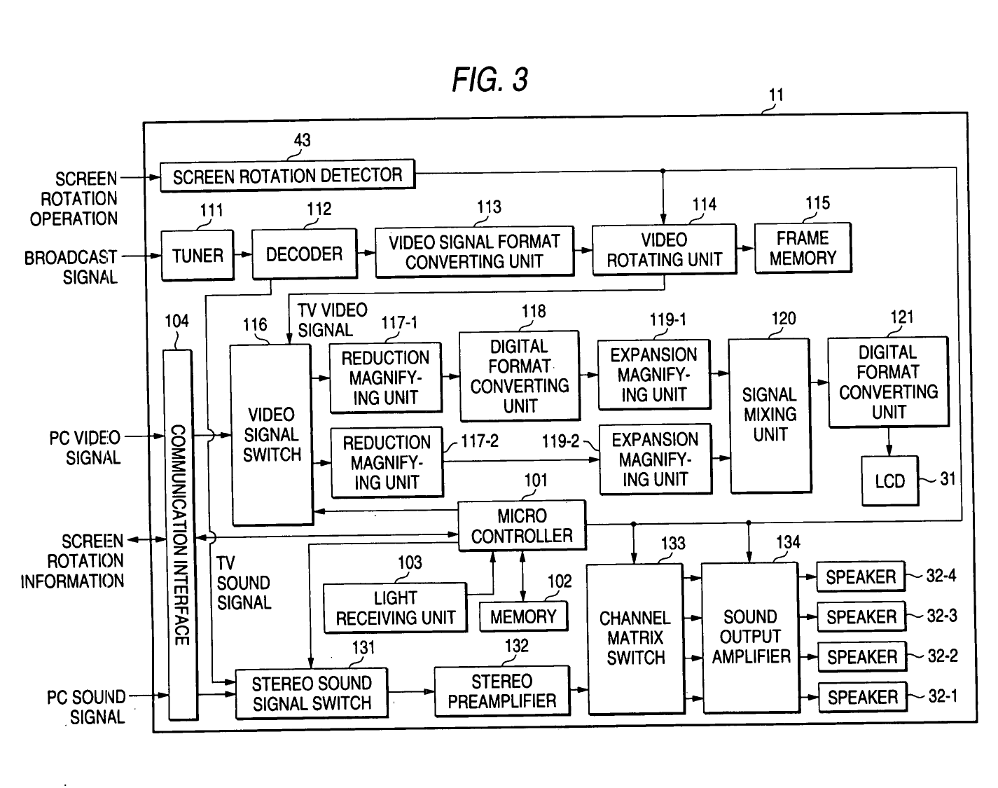

An information processing apparatus (for example, a display device 11 of FIG. 1) according to an embodiment of the present invention includes a display unit (for example, a display unit 21 of FIG. 1) which has a display surface (for example, an LCD 31 of FIG. 1) to display images, at least four speakers (for example, speakers 32-1 to 32-4 of FIG. 1) which are disposed in the periphery of the display surface on the display unit, a rotation detecting unit (for example, a screen rotation detector 43 of FIG. 3) which detects a 90 degree rotation of the display unit on a predetermined position of the display unit, and a switching unit (for example, a channel matrix switch 133 of FIG. 3) which switches left and right outputs of a pair of speakers (for example, speakers 32-1 and 32-3 of FIG. 1) at diagonal positions of the four speakers according to the 90 degree rotation of the display unit detected by the rotation detecting unit.

The information processing apparatus according to the embodiment of the present invention may further include a support unit (for example, a stand 22 of FIG. 1) which rotatably supports the display unit on the predetermined position of the display unit.

The information processing apparatus according to the embodiment of the present invention may further include an output adjusting unit (for example, a sound output amplifier 134 of FIG. 3) which adjusts output gains of the four speakers according to the 90 degree rotation of the display unit detected by the rotation detecting unit.

The information processing apparatus according to the embodiment of the present invention may further include a signal receiving unit (for example, a tuner 111 of FIG. 3) which receives a broadcast signal, a video rotating unit (for example, a video rotating unit 114 of FIG. 3) which rotates a video signal of the broadcast signal received by the signal receiving unit according to the 90 degree rotation of the display unit detected by the rotation detecting unit, and a display control unit (for example, a digital format converting unit 121 of FIG. 3) which performs control to display a video corresponding to the video signal rotated by the video rotating unit onto the display surface.

The information processing apparatus according to the embodiment of the present invention may further include a video magnifying unit (for example, an expansion magnifying unit 119-1 of FIG. 3) which magnifies the video signal rotated by the video rotating unit according to an image frame of the display unit whose 90 degree rotation is detected by the rotation detecting unit. In this case, the display control unit may perform control to display the video corresponding to the video signal magnified by the video magnifying unit onto the display surface.

The information processing apparatus according to the embodiment of the present invention may further include a transmitting unit (for example, a micro controller 101 of FIG. 3) which transmits information of the 90 degree rotation of the display unit detected by the rotation detecting unit to another information processing apparatus, and a superimposing unit (for example, a signal mixing unit 120 of FIG. 3) which superimposes the video signal rotated by the video rotating unit on a video signal from another information processing apparatus. In this case, the display control unit may perform control to display the video corresponding to a superimposed video signal by the superimposing unit onto the display surface.

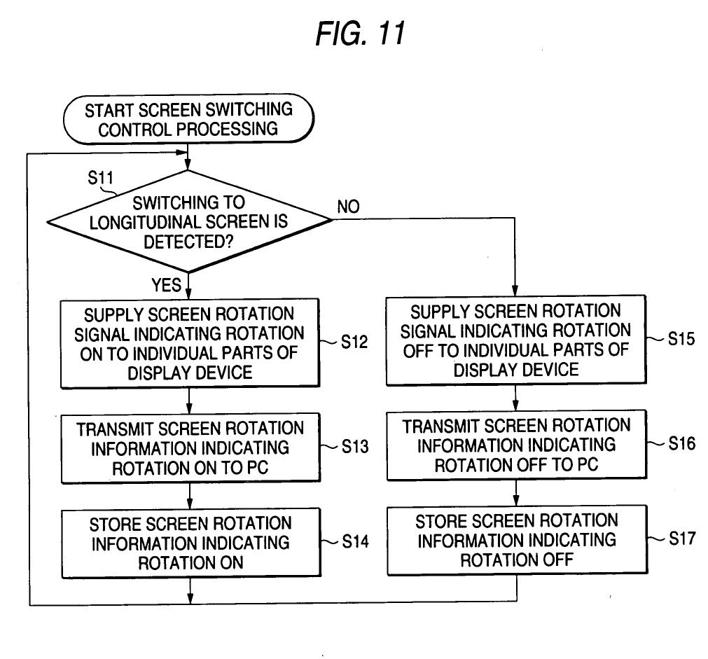

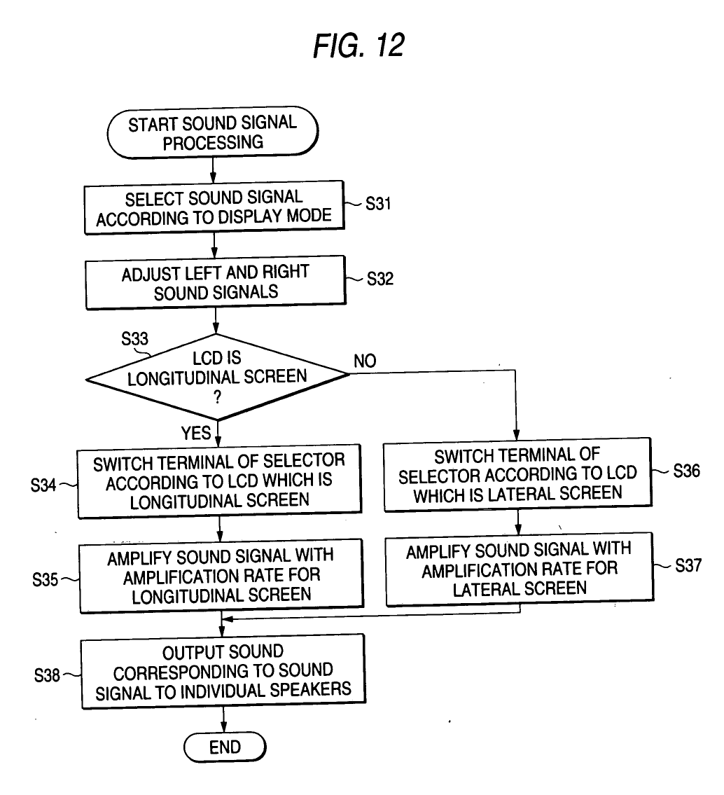

An information processing method according to another embodiment of the present invention includes the steps of detecting a 90 degree rotation of a display unit having a display surface to display the images on a predetermined position of the display unit (for example, a step S11 of FIG. 11), and switching left and right outputs of a pair of speakers at diagonal positions of at least four speakers disposed in the periphery of the display surface on the display unit according to the 90 degree rotation of the display unit detected by a processing at the rotation detecting step (for example, a step S34 of FIG. 12).

Moreover, a recording medium according to still another embodiment of the present invention and a program according to a further embodiment of the present invention basically have the same configuration as the information processing method according to another embodiment of the present invention, and thus the descriptions thereof will be omitted.

Hereinafter, embodiments of the present invention will be described with reference to the drawings.

FIG. 1 shows an example of the configuration of a display system to which the present invention is applied. In a display system 1, for example, a video of a broadcast signal received by a broadcast station (not shown) or a video of a signal from a personal computer (hereinafter, referred to as PC) 12, and sound of the broadcast signal or sound of the signal from the PC 12 are output to a display device 11.

Hereinafter, in order to discriminate between the signal from the broadcast station and the signal from the PC 12, a video signal and a sound signal obtained from the broadcast signal are individually referred to a television (TV) video signal and a TV sound signal, and the signals from the PC 12 are individually referred to as a PC video signal and a PC sound signal.

The display device 11 has a display unit 21 which has a built-in tuner 111 (FIG. 3) for receiving the broadcast signal from the broadcast station, and a stand 22 which rotatably supports the display unit 21 on a predetermined position at the back surface of the display unit 21.

At the front surface of a casing of the display unit 21, an LCD (Liquid Crystal Display) 31 is provided. The LCD 31 has a lateral (in case of FIG. 1) rectangle having the panel resolution (effective resolution) of 1680×1050. The LCD 31 displays a video corresponding to the TV video signal received by the built-in tuner 111 or the PC video signal from the PC 12. Moreover, what is necessary is that the LCD is a planar LCD 31 capable of displaying images. For example, a PDP (Plasma Display Panel) may be used. Further, an aspect ratio or resolution of the LCD 31 may be different from that of the example.

Further, at four corners of the front surface of the display unit 21, four speakers 32-1 to 32-4 which output stereo sound corresponding to the TV sound signal received by the built-in tuner 111 or the PC sound signal from the PC 12 are provided so as to surround the LCD 31.

In case of the example shown in FIG. 1, the speaker 32-1 is provided at an upper left corner of the front face of the display unit 21 in the drawing (that is, at an upper left corner toward the display unit 21), and outputs left sound corresponding to a left TV sound signal or a left PC sound signal. The speaker 32-2 is provided at an upper right corner of the front face of the display unit 21 in the drawing, and outputs right sound corresponding to a right TV sound signal or a right PC sound signal.

The speaker 32-3 is provided at a lower right corner of the front face of the display unit 21 in the drawing, and outputs right sound corresponding to a right TV sound signal or a right PC sound signal. The speaker 32-4 is provided at a lower left corner of the front face of the display unit 21 in the drawing, and outputs left sound corresponding to a left TV sound signal or a left PC sound signal.

That is, the speakers 32-1 and 32-4 or the speakers 32-2 and 32-3 are symmetrically disposed in a vertical direction with respect to the LCD 31, and the speakers 32-1 and 32-2 or the speakers 32-3 and 32-4 are symmetrically disposed in a horizontal direction with respect to the central portion of the display unit 21.

That is, the speakers 32-1 and 32-3 or the speakers 32-2 and 32-4 are located at diagonal positions with the LCD 31 interposed therebetween. Hereinafter, when the speakers 32-1 to 32-4 does not need to be individually discriminated, the speakers 32-1 to 32-4 are collectively referred to as the speakers 32.

The display unit 21 of the display device 11 is connected to the PC 12 by a composite PC communication cable 13 including a DDC (Display Data Channel) bus based on VESA (Video Electronics Standard Association) standard (hereinafter, referred to as DDC).

The display device 11 transmits and receives the video signal (R, G, B) or the sound signal, and other control signals to and from the PC 12 through the DDC 13. Further, the display device 11 transmits display device information including information regarding the display device 11, such as a display format or resolution of the display device 11 (LCD 31) to the PC 12 through the DDC 13.

Accordingly, the PC 12 transmits the video signal according to the received display device information to the display device 11 through the DDC 13. According to the PC video signal supplied from the PC 12, the display device 11 can display a predetermined video corresponding to the PC video signal onto the LCD 31.

In the PC 12, Windows (Registered Trademark) or the like is installed as an OS (Operating System), and predetermined application programs running on the OS, such as spreadsheet software, word processor software, Web browser software, and the like, are installed. Further, the PC 12 can be connected to a network, such as Internet (not shown) or the like, and can access a desired Web server by using Web browser software.

The PC 12 activates the OS or a predetermined application from the display device 11, generates desktop screen data according to the display device information received from the display device 11 through the DDC 13, and converts desktop screen data into a predetermined video signal. And then, the PC 12 transmits the video signal to the display device 11 through the DDC 13, and displays a video corresponding to the video signal onto the LCD 31 of the display device 11.

Further, when the predetermined application is activated, the PC 12 synthesizes generated desktop screen data and video data created by the predetermined application (for example, spreadsheet software or word processor software), converts synthesized data into a predetermined video signal, and transmits the converted video signal to the display device 11 through the DDC 13.

For example, when the resolution of 640×480 (VGA (Video Graphics Array)) or 1400×1050 (SXGA+(Super extended Graphics Array Plus)) size is described in the display device information, the PC 12 converts data into a video signal of a digital RGB signal of VGA or SXGA+size, and then transmits the video signal to the display device 11.

For example, the PC 12 can receive a video signal or a sound signal from a recording and reproducing apparatus of a hard disk recorder, a VCR (Video Cassette Recorder), or a DVD (Digital Versatile Disk) player, or an imaging device of a digital camera (digital still camera or digital video camera) through a predetermined input/output terminal. And then, the PC 12 can generate reproduced video data of the video signal or the sound signal, convert video data into a predetermined video signal, and transmit the video signal to the display device 11 through the DDC 13.

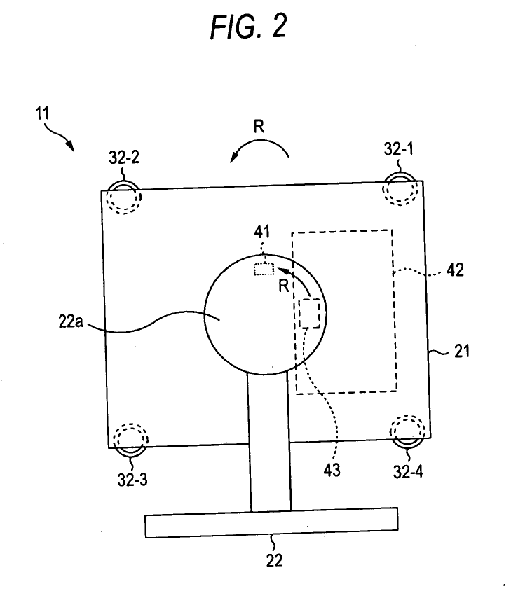

FIG. 2 is a rear view showing the exterior of the display device 11.

In the example shown in FIG. 2, in the stand 22 of the display device 11, there is provided a connecting portion 22a which is connected to substantially central portion of the display unit 21 so as to allow the display unit 21 to rotate in a counterclockwise direction (arrow R direction) in the drawing by 90 degrees on a predetermined position of the display unit 21 (in case of the example shown in FIG. 2, substantially central portion).

The connecting portion 22a is connected to substantially central portion of the display unit 21 through a joint member (not shown) provided at its substantially central portion so as to allow the display unit 21 to rotate in the counterclockwise direction in the drawing by 90 degrees. Moreover, though not described herein, in the connecting portion 22a, there is provided a mechanism which, when the display unit 21 is installed at a 0 degree position (lateral screen) or a 90 degree rotation position (longitudinal screen), holds the display unit 21 at that position.

Accordingly, a user rotates the display unit 21 in the counterclockwise direction R by 90 degrees, thereby installing the LCD 31, which is installed as the lateral screen as default, that is, which is installed in a screen direction to provide the lateral screen, as the longitudinal screen where the LCD 31 is installed in a screen direction to provide the longitudinal screen.

Hereinafter, a case where the LCD 31 is installed as the lateral screen is referred to as a case where the LCD 31 is the lateral screen, and the LCD 31 installed as the lateral screen is referred to as the LCD 31 installed in the state of the lateral screen or the LCD 31 of the lateral screen. The same is applied to a case of the longitudinal screen.

Further, in the example shown in FIG. 2, at a fixed position of a central upper portion of the connecting portion 22a in the drawing, there is provided a magnet 41 which detects a screen rotation.

In addition, the display unit 21 has a substrate 42 of the display device 11 built-in. On the substrate 42, there is provided a screen rotation detector 43 which, when the display unit 21 physically rotates by 90 degrees in the counterclockwise direction on substantially central portion of the display unit 21, detects a 90 degree rotation of the LCD 31 (that is, a 90 degree rotation of the display unit 21) at a position overlapping or passing through the magnet 41 provided in the connecting portion 22a.

The screen rotation detector 43 is, for example, a Hall element which generates an output voltage when a magnetic flux of the magnet 41 passes therethrough. Therefore, when the display unit 21 rotates by 90 degrees in the counterclockwise direction, the screen rotation detector 43 generates the output voltage while passing through the magnetic flux of the magnet 41, and detects the 90 decree rotation of the display unit 21, that is, the LCD 31 is the longitudinal screen. And then, the screen rotation detector 43 amplifies the generated output voltage by using a built-in operational amplifier (not shown), and supplies the amplified output voltage to the individual parts of the display device 11 as a screen rotation signal indicating screen rotation ON (1), that is, that the LCD 31 is installed as the longitudinal screen.

Accordingly, in the display device 11, a processing of video signals or sound signals according to the LCD 31 installed as the longitudinal screen is executed.

On the other hand, when the display unit 21 rotates in a clockwise direction in the drawing such that the LCD 31 installed in the state of the longitudinal screen is the lateral screen, that is, when the LCD 31 is not installed as the longitudinal screen, the screen rotation detector 43 does not generate the output voltage. In this case, therefore, the screen rotation signal indicating the screen rotation ON (1) is not supplied. That is, a screen rotation signal indicating screen rotation OFF (0) is supplied from the screen rotation detector 43 to the individual parts of the display device 11.

Accordingly, in the display device 11, a processing of video signals or sound signals according to the LCD 31 installed as the lateral screen is executed.

Moreover, the predetermined position, on which the display unit 21 rotates, is not limited to substantially central portion of the display unit 21. For example, regardless whether the LCD 31 is installed as the lateral screen or the longitudinal screen, the predetermined position is set according to the length of the stand 22 and the size of the display unit 21 such that a distance from an installation place is made proper.

FIG. 3 shows an example of the internal configuration of the display device 11. Moreover, in the example shown in FIG. 3, the same parts as those in FIGS. 1 and 2 are represented by the same reference numerals, and the descriptions thereof will be omitted.

According to the rotation operation of the display unit 21 by the user, the screen rotation detector 43 supplies the screen rotation signal indicating the screen rotation ON or OFF to a micro controller 101, a video rotating unit 114, a channel matrix switch 133, and a sound output amplifier 134.

The micro controller 101 controls a communication interface 104 to transmit screen rotation information indicating the screen rotation ON, that is, that the LCD 31 is the longitudinal screen, to the PC 12 through DDC 13 according to the screen rotation signal from the screen rotation detector 43. Moreover, this corresponds to a case where the PC 12 is not activated, and thus the micro controller 101 stores the screen rotation ON in the memory 102. Accordingly, when the PC 12 is activated, the screen rotation information can be provided to the PC 12.

Further, the micro controller 101 sets a display mode of the display device 11 according to control signals or the like supplied through a light-receiving unit 103 by an operation of a remote controller (not shown) by the user. The micro controller 101 controls a video signal switch 116 and a stereo sound signal switch 131 according to the set display mode, and allows display mode information to be transmitted to the PC 12 through the DDC 13. That is, in the display device information, the screen rotation information or the display mode information is also included.

The display mode includes a TV video display mode where the video of the TV video signal is displayed and sound of the TV sound signal is output in the display device 11, a PC video display mode where the video of the PC video signal is displayed and sound of the PC sound signal is output in the display device 11, and a W screen display mode where the video of the TV video signal is displayed on the video of the PC video signal as a child screen in the display device 11 or vice versa.

Moreover, in FIG. 3, though not shown, the micro controller 101 also controls reduction magnifying units 117-1 and 117-2, expansion magnifying units 119-1 and 119 2, and a signal mixing unit 120 according to the display mode.

The memory 102 has an EEPROM (Electrically Erasable Programmable ROM) flash memory, such as a mask ROM (Read Only Memory), an EPROM (Erasable Programmable ROM), or a flash memory, and records the display device information or basically fixed parameters required for processing of the micro controller 101.

The light-receiving unit 103 receives infrared rays from a remote controller (not shown) operated by the user, and supplies control signals corresponding to the received infrared rays to the micro controller 101.

The communication interface 104 receives the PC video signal transmitted from the PC 12 through the DDC 13 and outputs the received PC video signal to the video signal switch 116. Further, the communication interface 104 receives the PC sound signal transmitted from the PC 12 through the DDC 13, and outputs the received PC sound signal to the stereo sound signal switch 131.

Further, the communication interface 104 transmits the display device information, such as the screen rotation information or the display mode information, from the micro controller 101 to the PC 12 through the DDC 13 or receives the control signals or the like from the PC 12 and supplies them to the micro controller 101.

An antenna (not shown) receives broadcast signals from broadcast stations (not shown) and outputs the broadcast signals to the tuner 111 as RF (Radio Frequency) signals. The tuner 111 selects a signal of a predetermined broadcast station from the RF signals from the antenna, converts the RF signal into an analog VIF/SIF (Video Intermediate Frequency/Sound Intermediate Frequency) signal, that is, a video intermediate frequency signal and a sound intermediate frequency signal, modulates the intermediate frequency signals into baseband signals, and outputs the baseband signals to a decoder 112.

The decoder 112 decodes the video signal from the baseband signal of the video signal and the sound signal, and outputs the analog video signal to a video signal format converting unit 113. Further, the decoder 112 decodes the sound signal from the baseband signal of the video signal and the sound signal and supplies the analog sound signal to the stereo sound signal switch 131.

The video signal format converting unit 113 converts the analog video signal input from the decoder 112 into a digital video signal and outputs the converted digital video signal to the video rotating unit 114. 480i (interlaced) analog YC signals (brightness signals/color signals) are input from the decoder 112, and thus the video signal format converting unit 113 converts them into digital YCbCr signals (brightness signals/color difference signals) of 1024×768p (progressive), for example.

The video rotating unit 114 temporarily stores the digital video signal input from the video signal format converting unit 113 in a frame memory 115, reads out the digital video signal as it is, and outputs the read digital video signal of 1024×768 to the video signal switch 116. Further, when the screen rotation signal is supplied from the screen rotation detector 43, that is, in case of the screen rotation ON, the video rotating unit 114 rotates by 90 degrees and reads out the video signal stored in the frame memory 115, and outputs the video signal of 768×1024 rotated by 90 degrees to the video signal switch 116.

The frame memory 115 temporarily stores the video signals recorded by the video rotating unit 114, that is, the video signals required for a processing of the video rotating unit 114.

The video signal switch 116 selects at least one of the digital video signal input from the video rotating unit 114 (TV video signal) and the video signal from the PC 12 input through the communication interface 104 (PC video signal) according to the control of the micro controller 101. The video signal switch 115 outputs the selected TV video signal to the reduction magnifying unit 117-1 or outputs the selected PC video signal to the reduction magnifying unit 117-2.

When the display mode is the W screen display mode and the TV video signal is displayed on the child screen, the reduction magnifying unit 117-1 reduces the TV video signal input from the video signal switch 116 to the size of the child screen assigned in the display device 11 according to the screen rotation (whether the LCD 31 is the lateral screen or the longitudinal screen), and outputs the reduced TV video signal to a digital format converting unit 118.

For example, when the screen rotation is not in the ON state (the screen rotation is the OFF state), the video signal of 1024×768 is input, and thus the reduction magnifying unit 117-1 reduces the video signal to the size of the child screen (for example, 320×240 or 640×480) and outputs the reduced video signal. Further, when the screen rotation is in the ON state, the video signal of 768×1024 is input, and thus the reduction magnifying unit 117-1 reduces the video signal to the size of the child screen (for example, 240×320 or 480×640) and outputs the reduced video signal.

In other cases, that is, when the display mode is the TV video display mode or when the display mode is the W screen display mode and the TV video signal is displayed on a main screen, the reduction magnifying unit 117-1 outputs the TV video signal to the digital format converting unit 118 as it is.

Like the reduction magnifying unit 117-1, when the display mode is the W screen display mode and the PC video signal is displayed on the child screen, the reduction magnifying unit 117-2 reduces the PC video signal (for example, the digital RGB signal of 640×480 (VGA) size) input from the video signal switch 116 to the size of the assigned child screen and outputs the reduced PC video signal to an expansion magnifying unit 119-2. In other cases, the reduction magnifying unit 117-2 outputs the PC video signal to the expansion magnifying unit 119-2 as it is.

The digital format converting unit 118 adjusts image quality of the TV video signal (the digital YCbCr signal) from the reduction magnifying unit 117-1, converts the TV video signal into the digital RGB signal, and outputs the converted TV video signal (the digital RGB signal) to the expansion magnifying unit 119-1.

When the TV video signal is not displayed on the child screen, that is, in case of a full screen, and when the resolution of the input TV video signal is lower than the panel resolution (1680×1050) of the LCD 31, the expansion magnifying unit 119-1 expands the input TV video signal according to the screen rotation (whether the LCD 31 is the lateral screen or the longitudinal screen), and outputs the expanded TV video signal to the signal mixing unit 120. Further, when the TV video signal is displayed on the child screen, the expansion magnifying unit 119-1 outputs the TV video signal to the signal mixing unit 120 as it is.

For example, when the screen rotation is not in ON state (the screen rotation is in the OFF state), the video signal of 1024×768 is input, and thus the expansion magnifying unit 119-1 expands the video signal of 1024×768 to the size of the panel resolution size (1680×1050) of the LCD 31 and outputs the expanded video signal. However, when the screen rotation is in the ON state, the video signal of 768×1024 is input, and the video signal has an aspect ratio different from the panel resolution size (1680×1050) of the LCD 31. In this case, therefore, in the expansion magnifying unit 119-1, the TV video signal is expanded to the 786×1050 size, and then the expanded TV video signal is output. At this time, a black video signal is added to the remaining portion of the expanded TV video signal with no information.

When the PC video signal is not displayed on the child screen, that is, in case of the full screen, and the resolution of the input PC video signal (for example, the digital RGB signal of 640×480 (VGA) size) is lower than the panel resolution (1680×1050) of the LCD 31, the expansion magnifying unit 119-2 expands the input PC video signal and outputs the expanded PC video signal to the signal mixing unit 120. Further, when the PC video signal is displayed on the child screen, the expansion magnifying unit 119-2 outputs the PC video signal to the signal mixing unit 120 as it is.

Moreover, in the expansion magnifying unit 119-1 and the expansion magnifying unit 119-2, in addition to a linear expansion, a nonlinear expansion, such as a partial expansion or the like, is executed according to the display mode. Further, in case of the linear expansion, as described above, the size and the aspect ratio become different from those of the LCD 31. However, when the portion with no information needs to be displayed, in the expansion magnifying unit 119-1 or the expansion magnifying unit 119-2, each video signal is output to the signal mixing unit 120 with a black or blue video signal added thereto.

The signal mixing unit 120 receives at least one of the TV video signal from the expansion magnifying unit 119-1 and the PC video signal from the expansion magnifying unit 119-2. When one of the TV video signal (1680×1050) and the PC video signal (1680×1050) is input (that is, in case of the TV video display mode or the PC video display mode), the signal mixing unit 120 converts the input video signal into a signal of a TTL (Transistor-Transistor Logic) system, and outputs the converted video signal to the digital format converting unit 121.

When the TV video signal from the expansion magnifying unit 119-1 and the PC video signal from the expansion magnifying unit 119-2 are input, the signal mixing unit 120 superimposes (synthesizes) the video signal (320×240) of the child screen on the video signal (1680×1050) of the main screen, converts the superimposed video signal into the signal of the TTL system, and outputs the converted video signal to the digital format converting unit 121.

The digital format converting unit 121 converts the video signal of the TTL system input from the signal mixing unit 120 into a format corresponding to the LCD 31, such as LVDS (Low Voltage Differential Signaling), TMDS (Transition Minimized Differential signaling), or RSDS (Registered Trademark) (Reduced Swing Differential Signaling Interface), and outputs the converted video signal to the LCD 31.

Accordingly, onto the LCD 31, a video corresponding to the video signal from the digital format converting unit 121 is displayed.

The stereo sound signal switch 131 selects at least one of a stereo sound signal (TV sound signal) input from the decoder 112 and a stereo sound signal (PC sound signal) from the PC 12 input through the communication interface 104 and outputs the selected stereo sound signal to a stereo preamplifier 132 according to the control of the micro controller 101.

The stereo preamplifier 132 executes left and right volume adjustment and sound quality adjustment (tone control, loudness, silence) on the stereo sound signal input from the stereo sound signal switch 131 and outputs the adjusted stereo sound signal (left sound signal and right sound signal) to the channel matrix switch 133.

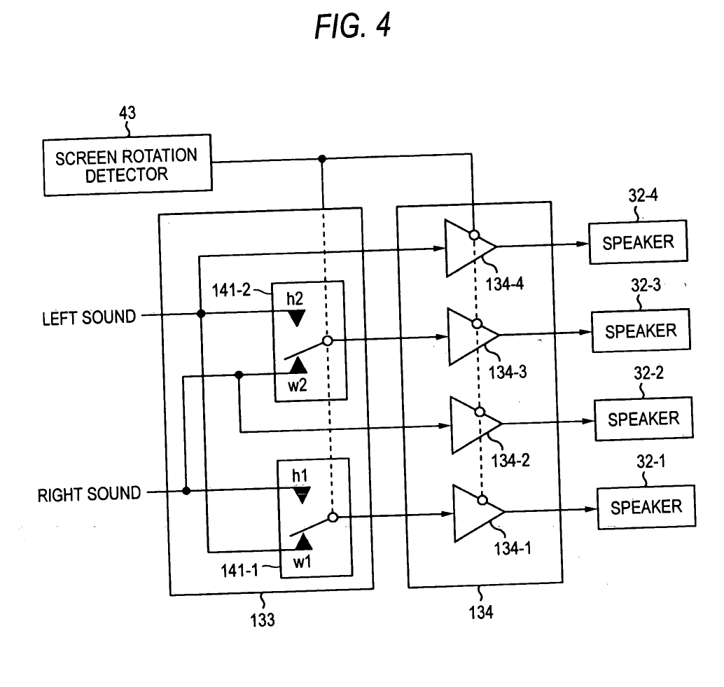

The channel matrix switch 133 has a selector 141 (FIG. 4) which correspondingly directs the left sound signal and the right sound signal input from the stereo preamplifier 132 to the speakers 32-1 to 32-4. The channel matrix switch 133 outputs the left sound signal and the right sound signal to the sound output amplifier 134 so as to be correspondingly output from the speakers 32-1 to 32-4 according to the screen rotation signal supplied from the screen rotation detector 43.

That is the channel matrix switch 133 switches the built-in selector 141 such that the left sound signal is output to the sound output amplifier 134 corresponding to the speakers 32 disposed on the left side, toward the front surface, at the front surface of the display unit 21 and outputting the left sound signal and the right sound signal is output to the sound output amplifier 134 corresponding to the speakers 32 disposed on the right side, toward the front surface, at the front surface of the display unit 21 and outputting the right sound signal.

The sound output amplifier 134 adjusts an amplification factor of the sound signal output to each speaker 32 according to the screen rotation signal supplied from the screen rotation detector 43, amplifies the sound signal with the adjusted amplification factor, and correspondingly outputs the amplified sound signal to the speakers 32.

That is, in the sound output amplifier 134, the amplification factors (gains) for the LCD 31 installed in the state of the lateral screen (that is, for the lateral screen) and for the LCD 31 installed in the state of the longitudinal screen (that is, for the longitudinal screen) are set in advance. The amplification factor is adjusted by switching the amplification factors according to the screen rotation signal supplied from the screen rotation detector 43.

FIG. 4 is a diagram showing an example of the detailed configuration of the channel matrix switch and the sound output amplifier shown in FIG. 3.

The channel matrix switch 133 has a selector 141-1 which switches the sound signal of sound output to the speaker 32-1, that is, the left and right sound signals input to a sound output amplifier 134-1, and a selector 141-2 which switches the sound signal of sound output to the speaker 32-3, that is, the left and right sound signal input to a sound output amplifier 134-3.

The selector 141-1 has a terminal w1 for selecting the left sound signal and a terminal h1 for selecting the right sound signal. When the screen rotation is in the OFF state and the LCD 31 is the lateral screen, the selector 141-1 selects the terminal w1 so as to output the left sound signal to the sound output amplifier 134-1. When the screen rotation is in the ON state and the LCD 31 is the longitudinal screen, the selector 141-1 selects the terminal h1 so as to output the right sound signal to the sound output amplifier 134-1.

The selector 141-2 has a terminal h2 for selecting the left sound signal and a terminal w2 for selecting the right sound signal. When the screen rotation is in the ON state and the LCD 31 is the longitudinal screen, the selector 141-2 selects the terminal h2 so as to output the left sound signal to the sound output amplifier 134-3. When the screen rotation is in the OFF state and the LCD 31 is the lateral screen, the selector 141-2 selects the terminal w2 so as to output the right sound signal to the sound output amplifier 134-3.

The sound output amplifier 134 has a sound output amplifier 134-1 for amplifying the sound signal output to the speaker 32-1, a sound output amplifier 134-2 for amplifying the sound signal output to the speaker 32-2, a sound output amplifier 134-3 for amplifying the sound signal output to the speaker 32-3, and a sound output amplifier 134-4 for amplifying the sound signal output to the speaker 32-4.

The sound output amplifiers 134-1 to 134-4, each having the amplification factors for the lateral screen and the longitudinal screen, correspond to the speakers 32-1 to 32-4 and switches the amplification factors according to the screen rotation ON or OFF. That is, when the screen rotation is in the OFF state and the LCD 31 is the lateral screen, the sound output amplifiers 134-1 to 134-4 amplify the sound signals with the amplification factor for the lateral screen. When the screen rotation is in the ON state and the LCD 31 is the longitudinal screen, the sound output amplifiers 134-1 to 134-4 amplify the sound signals with the amplification factor for the longitudinal screen.

In addition, in the example shown in FIG. 4, in the sound output amplifiers 134-1 to 134-4, the amplification factors according to the arrangement positions of the lateral screen and the longitudinal screen are set. For example, in order to lower a position of a sound field (virtual speaker position) generated by sound output from left and right speakers, it is configured such that the amplification factor for the lower longitudinal screen, not for the upper longitudinal screen, is increased. Further, in order to raise the position of the sound field, it is configured such that the amplification factor for the upper longitudinal screen, not for the lower longitudinal screen, is increased.

That is, the sound output amplifier 134-1 has the amplification factors for the upper lateral screen and the upper longitudinal screen, and the sound output amplifier 134-2 has the amplification factors for the upper lateral screen and the lower longitudinal screen. Further, the sound output amplifier 134-3 has the amplification factors for the lower lateral screen and the lower longitudinal screen, and the sound output amplifier 134-4 has the amplification factors for the lower lateral screen and the upper longitudinal screen.

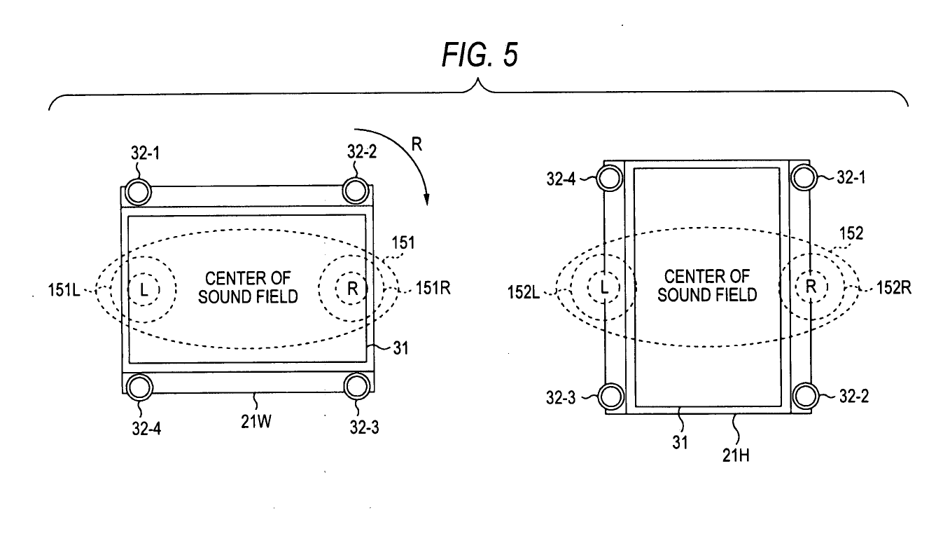

Next, a sound signal processing in the channel matrix switch and the sound output amplifier shown in FIG. 4 will be described with reference to FIG. 5.

In the example shown in FIG. 5, there are shown a display unit 21W of the lateral screen where the screen direction is installed such that the LCD 31 is the lateral screen, and a display unit 21H of the longitudinal screen where the display unit 21W of the lateral screen rotates by 90 degrees in the clockwise direction (arrow R direction, that is, counterclockwise direction in FIG. 2) on its substantially central portion and the screen direction is installed such that the LCD 31 is the longitudinal screen.

In the display unit 21W of the lateral screen, left sound is output from the speaker 32-4 disposed on a lower left side of the LCD 31 in the drawings. Further, the selector 141-1 selects the terminal w1, and then left sound is output from the speaker 32-1 disposed on an upper left side of the LCD 31 in the drawing.

Further, in the sound output amplifier 134-1 corresponding to the speaker 32-1 and the sound output amplifier 134-4 corresponding to the speaker 32-4, the amplification factors of left sound for the upper lateral screen and the lower lateral screen are set in advance, respectively, such that a sound field 151L of left sound is substantially generated at a medium position between the speakers 32-1 and 32-4 when the LCD 31 is the lateral screen (that is, the screen rotation is in the OFF state).

Therefore, in case of the display unit 21W of the lateral screen, the sound output amplifier 134-1 amplifies the left sound signal input through the selector 141-1 with the amplification factor of left sound for the upper lateral screen and outputs the amplified left sound signal to the speaker 32-1. The sound output amplifier 134-4 amplifies the input left sound signal with the amplification factor of left sound for the lower lateral screen and outputs the amplified left sound signal to the speaker 32-4.

Accordingly, the sound field (virtual speaker position) 151L of left sound is substantially generated at the medium position between the speakers 32-1 and 32-4 from sound output from the speakers 32-1 and 32-4.

Similarly, in case of the display unit 21W of the lateral screen, right sound is output from the speaker 32-2 disposed on an upper right side of the LCD 31 in the drawing. Further, the selector 141-2 selects the terminal w2, and then right sound is output from the speaker 32-3 disposed on a lower right side of the LCD 31 in the drawing.

Further, in the sound output amplifier 134-2 corresponding to the speaker 32-2 and the sound output amplifier 134-3 corresponding to the speaker 32-3, the amplification factors of right sound for the upper lateral screen and the lower lateral screen are set in advance, respectively, such that a sound field 151R of right sound is substantially generated at a medium position between the speakers 32-2 and 32-3 when the LCD 31 is the lateral screen (that is, the screen rotation is in the OFF state).

Therefore, in case of the display unit 21W of the lateral screen, the sound output amplifier 134-2 amplifies the input right sound signal with the amplification factor of right sound for the upper lateral screen and outputs the amplified right sound signal to the speaker 32-2. The sound output amplifier 134-3 amplifies the right sound signal input through the selector 141-2 with the amplification factor of right sound for the lower lateral screen and outputs the amplified right sound signal to the speaker 32-3.

Accordingly, the sound field 151R of right sound is substantially generated at the medium position between the speakers 32-2 and 32-3 from sound output from the speakers 32-2 and 32-3.

As such, in the display unit 21W of the lateral screen, switching is performed such that the center of the sound field substantially becomes the central portion of the display unit 21W of the lateral screen, and sound amplified with the adjusted amplification factors is output from the speakers 32-1 to 32-4, thereby providing a stereo sound field 151 having the sound field 151L of left sound and the sound field 151R of right sound. For this reason, the user can comfortably listen sound.

On the other hand, in the display unit 21H of the longitudinal screen where the display unit 21W rotates by 90 degrees in the clockwise direction (arrow R direction) on its substantially central portion and the screen direction is installed such that the LCD 31 is the longitudinal screen, the speaker 32-1, which is disposed on the left side of the display unit 21W of the lateral screen, is disposed on the right side. In the display unit 21H of the longitudinal screen, the speaker 32-3, which is disposed on the right side of the display unit 21W of the lateral screen, is disposed on the left side.

That is, in the display unit 21H of the longitudinal screen, left sound is output from the speaker 32-4 disposed on the upper left side of the LCD 31 in the drawing. Further, the selector 141-2 selects the terminal h2, and then left sound is output from the speaker 32-3 disposed on the lower left side of the LCD 31 in the drawing.

Further, in the sound output amplifier 134-4 corresponding to the speaker 32-4 and the sound output amplifier 134-3 corresponding to the speaker 32-3, the amplification factors of left sound for the upper longitudinal screen and the lower longitudinal screen are set in advance, respectively, such that a sound field 152L of left sound is substantially generated at a medium position between the speakers 32-4 and 32-3 when the LCD 31 is the longitudinal screen (that is, the screen rotation is in the ON state).

Therefore, in case of the display unit 21H of the longitudinal screen, the sound output amplifier 134-4 amplifies the input left sound signal with the amplification factor of left sound for the upper longitudinal screen and outputs the amplified left sound signal to the speaker 32-4. The sound output amplifier 134-3 amplifies the left sound signal input through the selector 141-2 with the amplification factor of left sound for the lower longitudinal screen and outputs the amplified left sound signal to the speaker 32-3.

Accordingly, the sound field 152L of left sound is substantially generated at the medium position between the speakers 32-3 and 32-4 from sound output from the speakers 32-3 and 32-4.

Similarly, in the display unit 21H of the longitudinal screen, right sound is output from the speaker 32-2 disposed on the lower right side of the LCD 31 in the drawing. Further, the selector 141-1 selects the terminal h1, and then right sound is output from the speaker 32-1 disposed on the upper right side of the LCD 31 in the drawing.

Further, in the sound output amplifier 134-1 corresponding to the speaker 32-1 and the sound output amplifier 134-2 corresponding to the speaker 32-2, the amplification factors of right sound for the upper longitudinal screen and the lower longitudinal screen are set in advance, respectively, such that a sound field 152R of right sound is substantially generated at a medium position between the speakers 32-1 and 32-2 when the LCD 31 is the longitudinal screen (that is, the screen rotation is in the ON state).

Therefore, in case of the display unit 21H of the longitudinal screen, the sound output amplifier 134-1 amplifies the right sound signal input through the selector 141-1 with the amplification factor of right sound for the upper longitudinal screen and outputs the amplified right sound signal to the speaker 32-1. The sound output amplifier 134-2 amplifies the input right sound signal with the amplification factor of right sound for the lower longitudinal screen and outputs the amplified right sound signal to the speaker 32-2.

Accordingly, the sound field 152R of right sound is substantially generated at the medium position between the speakers 32-1 and 32-2 from sound output from the speakers 32-1 and 32-2.

As such, in the display unit 21H of the longitudinal screen, switching is performed such that the center of the sound field substantially becomes the central portion of the display unit 21H of the longitudinal screen, and sound amplified with the adjusted amplification factors is output from the speakers 32-1 to 32-4, thereby providing a stereo sound field 152 having the sound field 152L of left sound and the sound field 152R of right sound. For this reason, the user can comfortably listen sound.

As described above, when the display unit 21 rotates by 90 degrees in the clockwise direction, sound output from a pair of speakers 32 (speakers 32-1 and 32-3) located at diagonal positions in the display unit 21 is switched. Therefore, even when the display unit 21 rotates by 90 degrees in the clockwise direction, it is possible to simply provide stereo sound to the user only by switching a pair of speakers.

Further, when the aspect ratio of the display unit 21 is different or when the display unit 21 substantially rotates on a position spaced at a predetermined distance from the central portion, not on substantially central portion, in the display unit 21H of the longitudinal screen where the display unit 21W rotates by 90 degrees, with the amplification factors set when the center of the sound field corresponds to the display unit 21W of the lateral screen, there may be a case in which the sound field of stereo sound is generated at a position shifted from a desired position of the display unit 21H of the longitudinal screen (for example, substantially central portion of the display unit 21H or a position below substantially central portion by 5 cm).

In such a case, with the rotation of the display unit 21, the sound field of stereo sound goes up and down. Accordingly, any user may rarely listen sound, and the user may have an uncomfortable feeling.

As a countermeasure against this problem, the amplification factors for the lateral screen and the longitudinal screen are set in the sound output amplifier 134 in advance, and the screen rotation signal is supplied from the screen rotation detector 43, whereby switching is performed according to the rotation of the display unit 21. Therefore, regardless whether the LCD 31 of the display unit 21 is in the state of the lateral screen or the longitudinal screen, the stereo sound field can be generated at an appropriate position according to the arrangement direction of the LCD 31.

Accordingly, it is possible to provide a comfortable stereo sound field to the user.

Moreover, in FIG. 5, there is described an example where the display unit 21 rotates by 90 degrees in the clockwise direction of the arrow R (that is, in the clockwise direction toward the display unit 21) on substantially central portion of the display unit 21. Alternatively, the display unit 21 may rotate by 90 degrees in the counterclockwise direction (that is, in the counterclockwise direction toward the display unit 21), which is a direction opposite to the arrow R shown in FIG. 5, on substantially central portion of the display unit 21.

In this case, in a display unit 21 (not shown) of the longitudinal screen where the display unit 21W of the lateral screen rotates by 90 degrees in the counterclockwise direction on its substantially central portion (the direction opposite to the arrow R) and the screen direction is installed such that the LCD 31 is the longitudinal screen, the speaker 32-4, which is disposed on the left side of the display unit 21W of the lateral screen, is disposed on the lower right side. Further, the speaker 32-2, which is disposed on the right side of the display unit 21W of the lateral screen, is disposed on the upper left side.

Therefore, the channel matrix switch 133 switches according to the reverse 90 degree rotation of the display unit 21 such that sound corresponding to the left sound signal is output to the speaker 32-2 to which right sound was output, and sound corresponding to the right sound signal is output to the speaker 32-4 to which left sound was output.

That is, in case of the reverse 90 degree rotation, in the channel matrix switch 133, it is configured such that sound output from a pair of speakers 32 (the speakers 32-2 and 32-4) located at diagonal positions in the display unit 21 is switched. Moreover, in this case, the video rotating unit 114 of the display device 11 and the PC 12 are also configured to execute the reverse 90 degree rotation of the video signal.

Hereinafter, if there is no specific reference, the rotation direction represents clockwise direction and the counterclockwise direction in the example shown in FIG. 5.

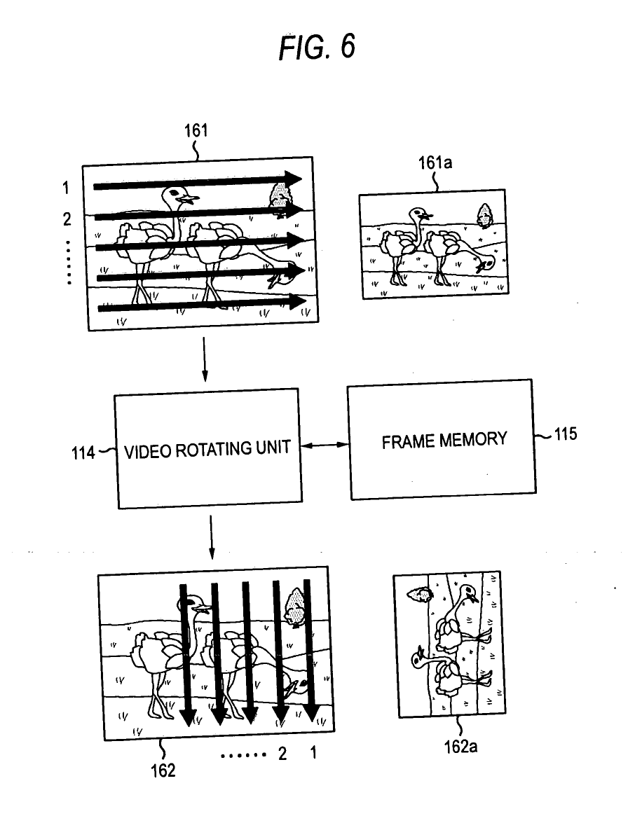

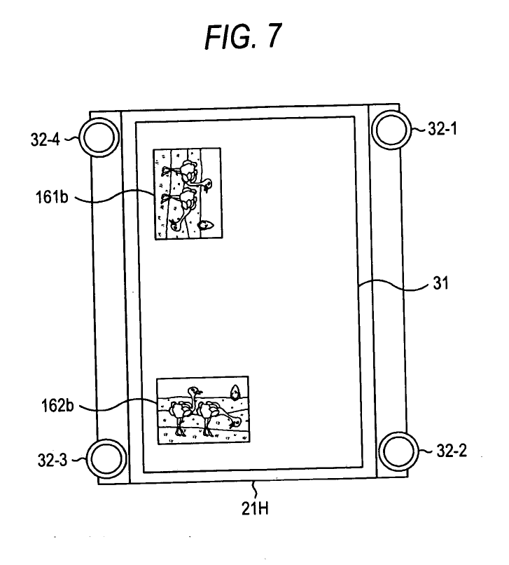

Next, a video signal processing in the video rotating unit shown in FIG. 4 will be described in detail with reference to FIGS. 6 and 7.

In the example shown in FIG. 6, there are shown a video 161 corresponding to a video signal input to the video rotating unit 114 and a video 162 corresponding to a video signal output from the video rotating unit 114 when the screen rotation is in the ON state. Moreover, arrows on the video 161 or the video 162 represent directions of scan lines of the corresponding video signal, and numerals appended to the arrows represent scan sequences.

The video 161 of the video signal which is obtained by converting the broadcast signal transmitted from the broadcast station into a predetermined format (for example, the digital YCbCr signal of 1024×768 p) is a video whose upper part erects upward in the drawing. The scan lines of the video signal are sequentially scanned from the upper left side in the drawing in a direction from the left to the right.

Like the video 161, a video 161a according to the video signal displayed onto a normal display (that is, the LCD 31 of the display unit 21W of the lateral screen where the screen rotation is in the OFF state) is displayed in a state where the upper part erects upward in the drawing.

However, when the video signal corresponding to the video 161 is displayed onto the LCD 31 of the display unit 21H of the longitudinal screen where the display unit 21W of the lateral screen rotates by 90 degrees, as shown in FIG. 7, a video 161b displayed onto the LCD 31 is displayed in a state where the right part erects upward in the drawing.

Therefore, in the display device 11, the screen rotation signal is supplied from the screen rotation detector 43 to the video rotating unit 114. And then, at the time of reading out the video signal which corresponds to the video 161 stored in the frame memory 115, if the screen rotation is in the ON state, the video signal which corresponds to the video 161 is rotated by 90 degrees in a direction opposite to the rotation direction of the display unit 21 and then is read out.

Accordingly, when the video 162 which corresponds to the video signal rotated by 90 degrees and read out is viewed as a video whose upper part erects upward in the drawing, the scan lines of the video signal are sequentially scanned from the upper right side in the drawing in a direction from the above to the below.

Therefore, the video 162a according to the video signal displayed onto the normal display (that is, the LCD 31 of the display unit 21W of the lateral screen where the screen rotation is in the OFF state) is displayed to be rotated by 90 degrees in the counterclockwise direction with respect to the video 162, that is, in a state where the left part erects upward in the drawing.

On the other hand, when the video signal corresponding to the video 162 is displayed onto the LCD 31 of the display unit 21H of the longitudinal screen, as shown in FIG. 7, a video 162b displayed onto the LCD 31 is displayed in a state where the upper part erects upward in the drawing.

As described above, when the display unit 21 rotates by 90 degrees in the clockwise direction, the video signal of the broadcast signal received by the display unit 21 is rotated by 90 degrees in the counterclockwise direction and is displayed onto the LCD 31. Therefore, even when the display unit 21 rotates by 90 degrees in the clockwise direction, it is possible to provide the erect TV video to the user.

Moreover, the above description is given by way of the video signal of the broadcast signal received by the tuner 111. Alternatively, a recording and reproducing apparatus, such as a hard disk recorder, a VCR, or a DVD player may be connected to the display device 11, and the same processing can be performed on video signals supplied from the recording and reproducing apparatus.

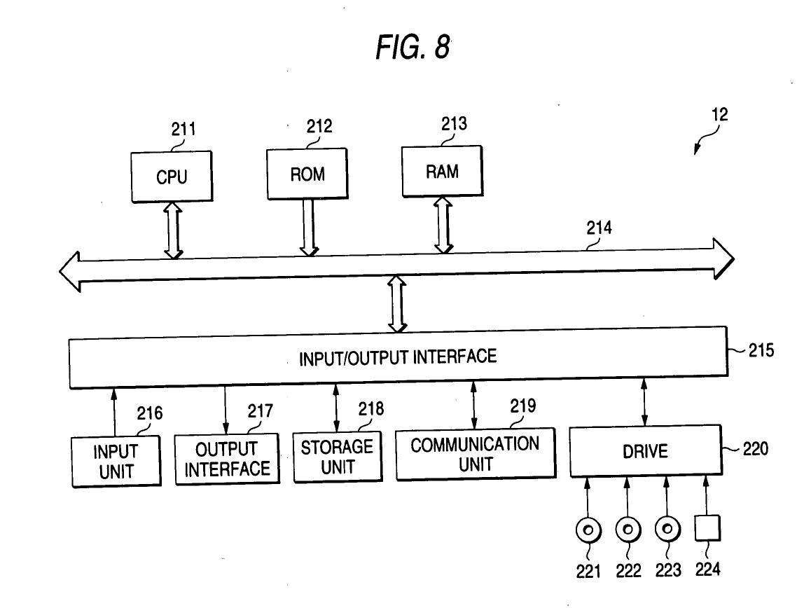

FIG. 8 shows an example of the hardware configuration of the PC 12.

A CPU (Central Processing Unit) 211 executes various kinds of processing according to a program stored in a ROM (Read Only Memory) 212 or a program loaded on a RAM (Random Access Memory) 213 from a storage unit 218. The RAM 213 also stores data required to allow the CPU 211 to execute various kinds of processing.

Here, as a program which is loaded on the RAM 213 from the storage unit 218 and on which a processing is executed by the CPU 211, in addition to the OS, spreadsheet software, and Web browser software, a signal generation processing program which acquires the display device information of the display device 11 and generates the video signal and the sound signal according to the display device information is used. Moreover, the signal generation processing program is preferably a resident program.

The CPU 211, the ROM 212, and the RAM 213 are connected to one another through a bus 214. An input/output interface 215 is also connected to the bus 214.

An input unit 216 having a keyboard or a mouse, an output interface 217 having input/output terminals for the DDC 13 and transmitting and receiving the video signal, the sound signal, and the control signals to and from the display device 11, a storage unit 218 having a hard disk and storing various programs, such as the OS, spreadsheet software, and the signal generation processing program, and a communication unit 219 having a modem or a terminal adaptor are connected to the input/output interface 215.

The program stored in the storage unit 218 is loaded on the RAM 213 or the like through the control of the CPU 211 on the basis of an operation signal from the input unit 216 corresponding to the user's operation. The communication unit 219 performs communication processing through a network, such as Internet (not shown).

If necessary, a drive 220 is connected to the input/output interface 215, and a magnetic disk 221, an optical disk 222, a magneto-optical disk 223, and a semiconductor memory 224 are properly mounted on the drive 220. If necessary, a computer program read out from the disk is installed in the storage unit 218.

When a series of processing is executed by software, a program constituting software is installed from the network or the recording medium, for example, in a computer which is incorporated in dedicated hardware or a general-use personal computer which can execute various functions by installing various programs.

As shown in FIG. 8, the recording medium may be package media which is distributed to provide the program to the user separately from the apparatus main body, such as the magnetic disk 221 (including a flexible disk), the optical disk 222 (including CD-ROM (Compact Disk-Read Only Memory) and DVD (Digital Versatile Disk)), the magneto-optical disk 223 (including MD (Mini-Disk) (Trademark)), or the semiconductor memory 224, which has a program recorded therein. Further, the recording medium may be the ROM 212 recorded with a program or a hard disk included in the storage unit 218, which is provided to the user while being incorporated in the apparatus main body in advance.

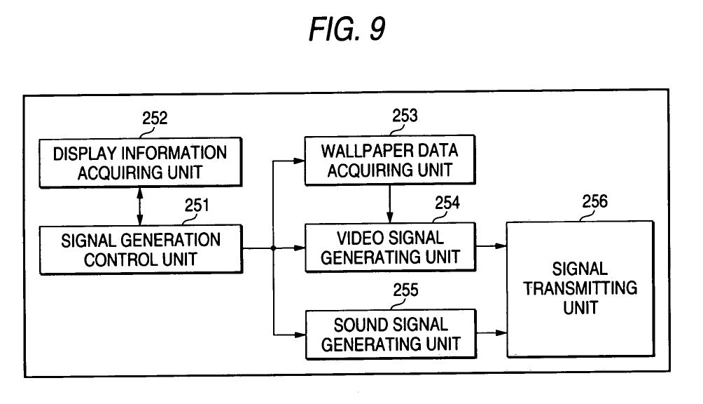

FIG. 9 is a block diagram showing an example of the functional configuration of the PC 12 which performs a processing for acquiring the display device information from the display device 11 and generating the video signal and the sound signal according to the display device information.

The functional blocks shown in FIG. 9 are implemented by causing the OS to be activated by the CPU 211 of the PC 12 and causing the signal generation processing program to be executed.

A signal generation control unit 251 controls a wallpaper data acquiring unit 253, a video signal generating unit 254, and a sound signal generating unit 255 according to the display device information (that is, the display format or resolution, the screen rotation information, the display mode information, and the like) supplied from a display information acquiring unit 252, and generates the video signal or the sound signal which is output to the LCD 31 of the display device 11.

Just after activation, the signal generation control unit 251 also controls the display information acquiring unit 252 to request the display device 11 for the display device information through the DDC 13.

The display information acquiring unit 252 acquires the display device information from the display device 11 received by the output interface 217 through the DDC 13 and supplies the acquired display device information to the signal generation control unit 251. Further, the display information acquiring unit 252 requests the display device 11 for the display device information according to the control of the signal generation control unit 251.

The wallpaper data acquiring unit 253 acquires wallpaper data for the lateral screen or wallpaper data for the longitudinal screen from the storage unit 218 or the like as wallpaper data set as a wallpaper in a desktop according to the control from the signal generation control unit 251, and outputs acquired wallpaper data to the video signal generating unit 254.

Moreover, when only wallpaper data for the lateral screen is stored in the storage unit 218, the wallpaper data acquiring unit 253 may generate wallpaper data for the longitudinal screen and output generated wallpaper data for the longitudinal screen to the video signal generating unit 254.

The video signal generating unit 254 generates desktop screen data for the lateral screen or the longitudinal screen according to the control from the signal generation control unit 251 and synthesizes wallpaper data acquired by the wallpaper data acquiring unit 253 or video data generated by another program on activation to generated desktop screen data. Further, the video signal generating unit 254 converts video data into a video signal (for example, a digital RGB signal of VGA or SXGA+ size) according to the display format or resolution of the display device 11, and outputs the converted video signal to the signal transmitting unit 256.

The sound signal generating unit 255 converts sound data obtained from the OS or another program on activation into a sound signal according to the output of the display device 11 through the control from the signal generation control unit 251 and outputs the converted sound signal to the signal transmitting unit 256.

The signal transmitting unit 256 transmits the video signal input from the video signal generating unit 254 and the sound signal input from the sound signal generating unit 255 to the display device 11 through the output interface 217 and the DDC 13.

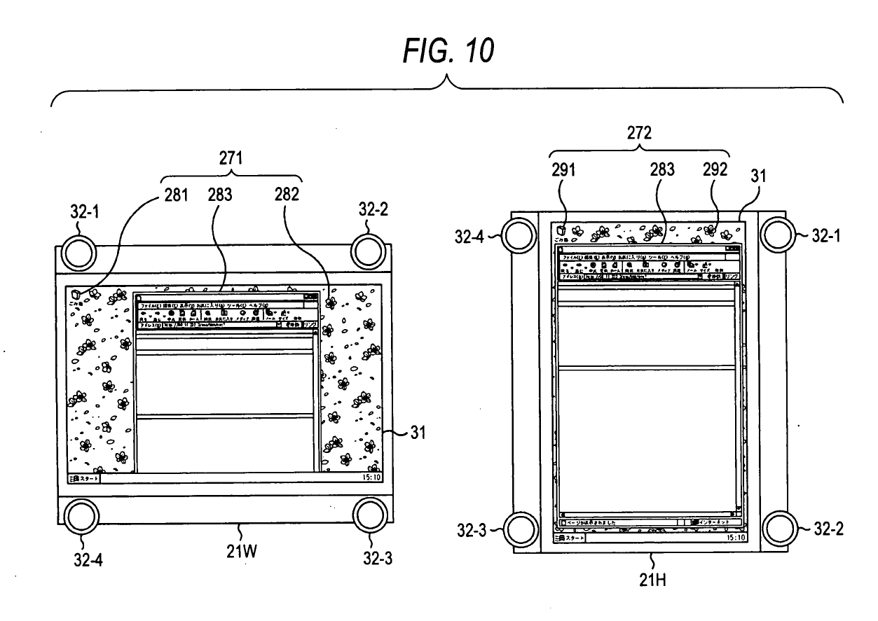

FIG. 10 shows a display example of a video corresponding to the PC video signal displayed onto the LCD 31 of the display unit 21. In the example shown in FIG. 10, the display unit 21W of the lateral screen and the display unit 21H of the longitudinal screen described with reference to FIG, 5 are shown. The same parts as these in FIG. 5 are represented by the same reference numerals, and the descriptions thereof will be omitted.

In the example shown in FIG. 10, onto the LCD 31 of the display unit 21W of the lateral screen, a video 271 corresponding to the PC video signal received from the PC 12 through the DDC 13 is displayed.

The video 271 has a desktop video 281 for the lateral screen, such as icons or a menu bar, a cherry-like wallpaper 282 for the lateral screen, and an application window 283.

That is, when receiving the screen rotation information indicating that the screen rotation is in the OFF state (that is, the LCD 31 is installed as the lateral screen) from the display device 11 through the DDC 13, the video signal generating unit 254 of the PC 12 generates video data of the desktop video 281 for the lateral screen according to the screen rotation information. Further, the video signal generating unit 254 synthesizes video data of the wallpaper 282 for the lateral screen acquired by the wallpaper data acquiring unit 253 and video data of the application window 283 generated by another program on activation in the PC 12 to generated video data of the desktop video 281.

Next, the video signal generating unit 254 converts video data into the video signal according to the display format or resolution of the display device 11 and transmits the converted video signal to the display device 11 through the DDC 13. Accordingly, in the display device 11, the video 271 generated for the lateral screen is displayed onto the LCD 31 of the display unit 21W of the lateral screen when the screen rotation is in the OFF state.

On the other hand, onto the LCD 31 of the display unit 21H of the longitudinal screen when the display unit 21W of the lateral screen rotates by 90 degrees in the clockwise direction on its substantially central portion and the screen direction is installed such that the LCD 31 is the longitudinal screen, a video 272 corresponding to the PC video signal received from the PC 12 through the DDC 13 is displayed.

The video 272 has a desktop video 291 for the longitudinal screen, such as icons or a menu bar, a cherry-like wallpaper 292 for the longitudinal screen, and an application window 283.

That is, when receiving the screen rotation information indicating that the screen rotation is in the ON state (that is, the LCD 31 is installed as the longitudinal screen) from the display device 11 through the DDC 13, the video signal generating unit 254 of the PC 12 generates video data of the desktop video 291 for the longitudinal screen according to the screen rotation information. Further, the video signal generating unit 254 synthesizes video data of the wallpaper 292 for the longitudinal screen acquired by the wallpaper data acquiring unit 253 and video data of the application window 283 acquired from another program on activation to generated video data of the desktop video 291. Moreover, video data of the application window 283 is the same, regardless of the lateral screen or the longitudinal screen.

Next, the video signal generating unit 254 converts video data into a video signal according to the display format or resolution of the display device 11 and transmits the converted video signal to the display device 11. Accordingly, in the display device 11, the video 272 generated for the longitudinal screen is displayed onto the LCD 31 of the display unit 21H of the longitudinal screen when the screen rotates by 90 degrees.

Next, an example of a screen switching control processing of the display device 11 will be described with reference to a flowchart of FIG. 11.

If a power button (not shown) is operated by the user and power is supplied to the individual parts of the display device 11, the screen rotation detector 43 judges whether or not switching of the LCD 31 to the longitudinal screen is detected, that is, whether or not it is detected that the display unit 21 physically rotates by 90 degrees and the LCD 31 is installed as the longitudinal screen.

If the user physically rotates the display unit 21 by 90 degrees in the clockwise direction (FIG. 5) on substantially central portion of the display unit 21 and the magnetic flux of the magnet 41 incorporated in the stand 22 passes therethrough, the screen rotation detector 43 generates the output voltage.

Accordingly, the screen rotation detector 43 judges that switching of the LCD 31 to the longitudinal screen is detected, and then the process progresses to a step S12. At the step S12, the generated output voltage is amplified by the built-in operational amplifier (not shown), and the amplified output voltage is supplied to the individual parts of the display device 11 (that is, the micro controller 101, the video rotating unit 114, the channel matrix switch 133, and the sound output amplifier 134) as the screen rotation signal indicating the screen rotation ON (1).

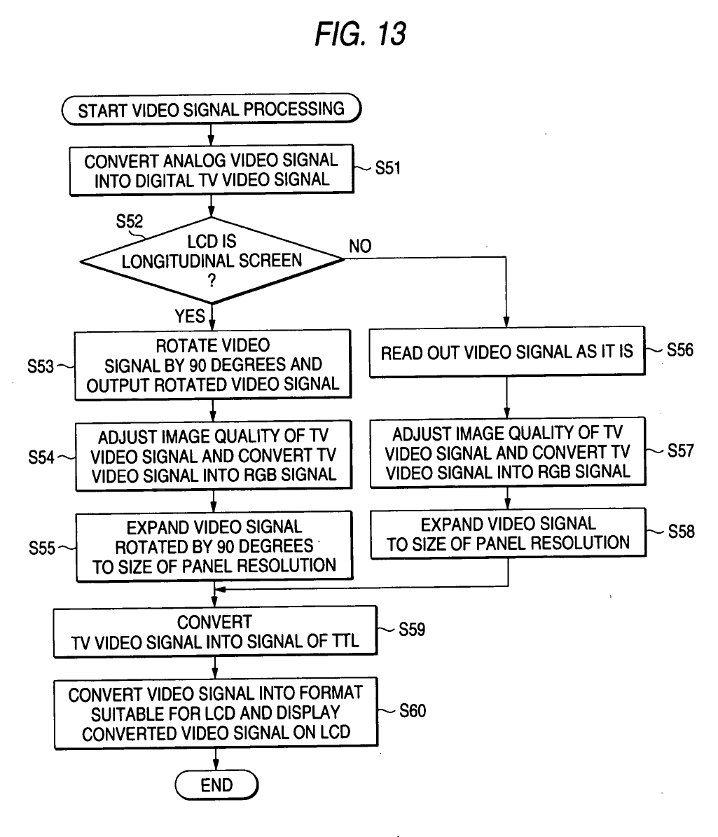

Moreover, in response to the screen rotation signal, the video rotating unit 114 executes a video signal processing described below with reference to FIG. 13, and the channel matrix switch 133 and the sound output amplifier 134 execute a sound signal processing described below with reference to a flowchart of FIG. 12.

When the screen rotation signal is supplied, at a step S13, the micro controller 101 controls the communication interface 104 to transmit the screen rotation information indicating the screen rotation ON (that is, the LCD 31 is the longitudinal screen) to the PC 12 through the DDC 13, and then the process progresses to a step S14. At the step S14, the screen rotation information indicating the screen rotation ON is stored in the memory 102, and then the process returns to the step S11. Subsequently, the steps are repeatedly executed.

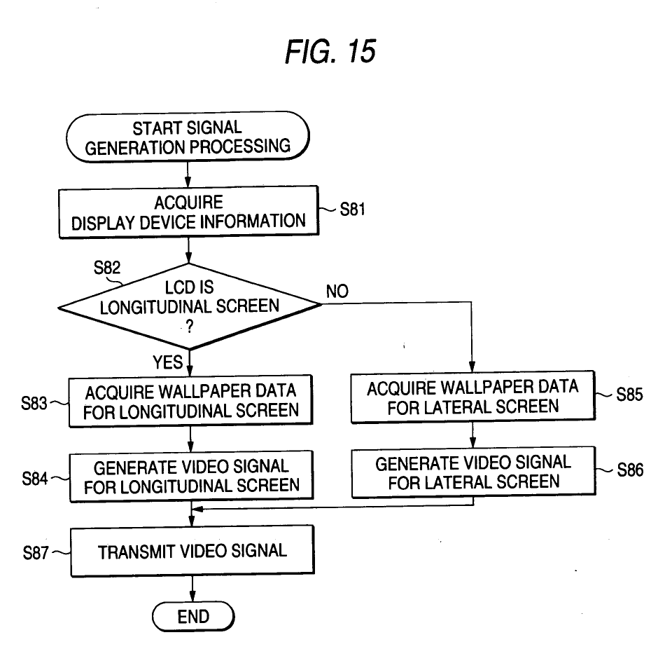

In response to this processing, the PC 12 executes a signal generation processing described below with reference to FIG. 15.

On the other hand, when the display unit 21 rotates in the counterclockwise direction (FIG. 5) such that the LCD 31 installed in the state of the longitudinal screen is in the state of the lateral screen or when the LCD 31 installed in the lateral screen is maintained, that is, when the LCD 31 is not installed as the longitudinal screen, the magnetic flux of the magnet 41 incorporated into the stand 22 does not pass therethrough, and thus the screen rotation detector 43 does not generate the output voltage.

Therefore, at the step S11, the screen rotation detector 43 judges that switching of the LCD 31 to the longitudinal screen is not detected, and then the process progresses to a step S15. At the step S15, the screen rotation signal indicating the screen rotation OFF (0) is supplied to the individual parts of the display device 11 (that is, the micro controller 101, the video rotating unit 114, the channel matrix switch 133, and the sound output amplifier 134).

Moreover, in response to the screen rotation signal, the video rotating unit 114 executes the video signal processing described below with reference to FIG. 13, and the channel matrix switch 133 and the sound output amplifier 134 execute the sound signal processing described below with reference to FIG. 12.

If the screen rotation signal is supplied, at a step S16, the micro controller 101 controls the communication interface 104 to transmit the screen rotation information indicating the screen rotation OFF (that is, the LCD 31 is the lateral screen) to the PC 12 through the DDC 13, and then the process progresses to a step S17. At the step S17, the screen rotation information indicating the screen rotation OFF is stored in the memory 102, and then the process returns to the step S11. Subsequently, the steps are repeatedly executed.

In response to this processing, the PC 12 executes the signal generation processing described below with reference to FIG. 15.

As described above, the physical rotation of the display unit 21 by the user is electrically detected and the screen rotation ON or OFF (that is, the LCD 31 is installed as the longitudinal screen or is installed as the lateral screen) is supplied to the individual parts of the display device 11 and the PC 12. Accordingly, in the display device 11 and the PC 12, the controls of the video signal and the sound signal are executed according to the screen direction where the LCD 31 is installed.

Next, an example of the sound signal processing of the display device 11 will be described with reference to FIG. 12.

In the display device 11, the antenna (not shown) receives the broadcast signal from the broadcast station (not shown) and outputs the received broadcast signal to the tuner 111 as the RF signal. The tuner 111 selects a signal of a predetermined broadcast station among the RF signals from the antenna, converts the selected RF signal into the analog VIF/SIF signal, that is, the video intermediate frequency signal and the sound intermediate frequency signal, demodulates the converted signal to the baseband signal, and outputs the baseband signal to the decoder 112. And then, the decoder 112 decodes the sound signal from the baseband signal of the video signal and the sound signal and inputs the analog sound signal to the stereo sound signal switch 131.

On the other hand, the PC 12 converts sound data obtained from the OS or another program on activation into the PC sound signal according to the output of the display device 11. The converted PC sound signal is input to the stereo sound signal switch 131 through the DDC 13 and the communication interface 104.

If at least one of the stereo sound signals of the TV sound signal from the decoder 112 and the PC sound signal from the communication interface 104 is input, at a step S31, the stereo sound signal switch 131 selects the stereo sound signal according to the display mode set by the user's operation of the remote controller among the input stereo sound signals through the control of the micro controller 101, and outputs the selected stereo sound signal to the stereo preamplifier 132. And then, the process progresses to a step S32.

When receiving the stereo sound signal from the stereo sound signal switch 131, at the step S32, the stereo preamplifier 132 adjusts the input left and right sound signals. That is, the stereo preamplifier 132 executes volume adjustment and sound quality adjustment (tone control, loudness, and silence) according to left and right, and outputs the adjusted stereo sound signal (lift sound signal and right sound signal) to the channel matrix switch 133. And then, the process progresses to a step S33.

If the left sound signal and the right sound signal are input from the stereo preamplifier 132, at the step S33, the channel matrix switch 133 judges on the basis of the screen rotation signal supplied from the screen rotation detector 43 at the step S12 or S15 of FIG. 11 whether or not the LCD 31 is the longitudinal screen.

At the step S33, when it is judged that the screen rotation signal represents the screen rotation ON and the LCD 31 is the longitudinal screen, the process progresses to a step S34. At the step S34, the channel matrix switch 133 switches the terminal of the selectors 141-1 and 141-2 according to the LCD 31 of the lateral screen, and then the process progresses to a step S35.

That is, in the channel matrix switch 133, the selector 141-1 selects the terminal h1, and the selector 141-2 selects the terminal h2. Therefore, the left sound signal is output to the sound output amplifier 134-3 and the sound output amplifier 134-4, and the right sound signal is output to the sound output amplifier 134-1 and the sound output amplifier 134-2.

Moreover, though not shown, in the sound output amplifier 134, the same judgment as that at the step S33 is made, and it is judged that the screen rotation signal represents the screen rotation ON and the LCD 31 is the longitudinal screen.

Therefore, if the left sound signal and the right sound signal are input from the channel matrix switch 133, at the step S35, the sound output amplifier 134 amplifies the input sound signal with the amplification factor for the longitudinal screen. Further, at a step S38, the sound output amplifier 134 outputs the amplified sound signal to the corresponding speaker 32.

Specifically, the sound output amplifier 134-1 amplifies the right sound signal input through the selector 141-1 with the amplification factor of right sound for the upper longitudinal screen at the step S35, and outputs the amplified right sound signal to the speaker 32-1 at the step S38. The sound output amplifier 134-2 amplifies the input right sound signal with the amplification factor of right sound for the lower longitudinal screen at the step S35, and outputs the amplified right sound signal to the speaker 32-2 at the step S38.

The sound output amplifier 134-3 amplifies the left sound signal input through the selector 141-2 with the amplification factor of left sound for the lower longitudinal screen at the step S35, and outputs the amplified left sound signal to the speaker 32-3 at the step S38. The sound output amplifier 134-4 amplifies the input left sound signal with the amplification factor of left sound for the upper longitudinal screen at the step S35, and outputs the amplified left sound signal to the speaker 32-4 at the step S38. And then, the sound signal processing ends.

Accordingly, as described above with reference to FIG. 5, in the display unit 21H (LCD 31) of the longitudinal screen, right sound is output from the speakers 32-1 and 32-2, and the sound field 152R of right sound is substantially generated at the medium position between the speakers 32-1 and 32-2 by sound output from the speakers 32-1 and 32-2. Further, left sound is output from the speakers 32-3 and 32-4, and the sound field 152L of left sound is substantially generated at the medium position between the speakers 32-3 and 32-4 by sound output from the speakers 32-3 and 32-4.

That is, in the display unit 21H of the longitudinal screen shown in FIG. 5, switching is made such that the center of the sound field becomes substantially central portion of the display unit 21H of the longitudinal screen, and sound amplified with the adjusted amplification factor is output from the speakers 32-1 to 32-4. Therefore, it is possible to provide the sound field 152 of stereo sound having the sound field 152L of left sound and the sound field 152R of right sound to the user.

On the other hand, when it is judged at the step S33 that the screen rotation signal represents the screen rotation OFF and the LCD 31 is the lateral screen, the process progresses to a step S36. At the step S36, the channel matrix switch 133 switches the terminal of the selectors 141-1 and 141-2 according to the LCD 31 of the lateral screen, and then the process progresses to a step S37.

That is, in the channel matrix switch 133, the selector 141-1 selects the terminal w1, and the selector 141-2 selects the terminal w2. Therefore, the left sound signal is output to the sound output amplifier 134-1 and the sound output amplifier 134-4, and the right sound signal is output to the sound output amplifier 134-2 and the sound output amplifier 134-3.

Moreover, though not shown, in the sound output amplifier 134, the same judgment as that at the step S33 is made, and it is judged that the screen rotation signal represents the screen rotation OFF and the LCD 31 is the lateral screen.

Therefore, if the left sound signal and the right sound signal are input from the channel matrix switch 133, at the step S37, the sound output amplifier 134 amplifies the input sound signal with the amplification factor for the lateral screen. Further, at the step S38, the sound output amplifier 134 outputs the amplified sound signal to the corresponding speaker 32.

Specifically, the sound output amplifier 134-1 amplifies the left sound signal input through the selector 141-1 with the amplification factor of left sound for the upper lateral screen at the step S37, and outputs the amplified left sound signal to the speaker 32-1 at the step S38. The sound output amplifier 134-2 amplifies the input right sound signal with the amplification factor of right sound for the upper lateral screen at the step S37, and outputs the amplified right sound signal to the speaker 32-2 at the step S38.

The sound output amplifier 134-3 amplifies the right sound signal input through the selector 141-2 with the amplification factor of right sound for the lower lateral screen at the step S37, and outputs the amplified right sound signal to the speaker 32-3 at the step S38. The sound output amplifier 134-4 amplifies the input left sound signal with the amplification factor of left sound for the lower lateral screen at the step S37, and outputs the amplified left sound signal to the speaker 32-4 at the step S38. And then, the sound signal processing ends.

Accordingly, as described above with reference to FIG. 5, in the display unit 21W of the lateral screen, right sound is output from the speakers 32-2 and 32-3, and the sound field 151R of right sound is substantially generated at the medium position between the speakers 32-2 and 32-3 by sound output from the speakers 32-2 and 32-3. Further, left sound is output from the speakers 32-1 and 32-4, and the sound field 151L of left sound is substantially generated at the medium position between the speakers 32-1 and 32-4 by sound output from the speakers 32-1 and 32-4.

That is, in the display unit 21W of the lateral screen shown in FIG. 5, switching is made such that the center of the sound field becomes substantially central portion of the display unit 21W of the lateral screen, and sound amplified with the adjusted amplification factor is output from the speakers 32-1 to 32-4. Therefore, it is possible to provide the sound field 151 of stereo sound having the sound field 151L of left sound and the sound field 151R of right sound to the user.

As described, even when the display unit 21 rotates by 90 degrees in the clockwise direction of FIG. 5 and the screen direction of the LCD 31 is changed from the lateral screen to the longitudinal screen or vice versa, it is possible to simply provide stereo sound to the user only by switching sound output from a pair of speakers 32 (the speakers 32-1 and 32-3) located at diagonal positions in the display unit 21.

Further, the amplification factors for the lateral screen and the longitudinal screen are set in the sound output amplifier 134 in advance, and switching is made according to the rotation of the display unit 21. Therefore, regardless whether the LCD 31 of the display unit 21 is disposed in the state of the lateral screen or the longitudinal screen, the stereo sound field can be generated at an appropriate position according to the arrangement direction of the LCD 31.

Accordingly, it is possible to provide a comfortable stereo sound field to the user.

Next, an example of the video signal processing of the display device 11 will be described with reference to a flowchart of FIG. 13. Moreover, in FIG. 13, as an example, in the display device 11, the TV video display mode where the video of the TV video signal is displayed and sound of the TV sound signal is output is set.

In the display device 11, the antenna (not shown) receives the broadcast signal from the broadcast station (not shown), and outputs the received broadcast signal to the tuner 111 as the RF signal. The tuner 111 selects a signal of a predetermined broadcast station among the RF signals from the antenna, converts the selected RF signal into an analog VIF/SIF signal, that is, the video intermediate frequency signal and the sound intermediate frequency signal, demodulates the converted signal to the baseband signal, and outputs the baseband signal to the decoder 112.

The decoder 112 decodes the video signal from the baseband signal of the video signal and the sound signal, and outputs the analog video signal to the video signal format converting unit 113.

If the analog video signal is input from the decoder 112, at a step S51, the video signal format converting unit 113 converts the analog video signal into the digital video signal. That is, the video signal format converting unit 113 converts the analog YC signal of 480i from the decoder 112 into the digital YCbCr signal of 1024×768p (brightness signal or color difference signal) and outputs the digital YCbCr signal to the video rotating unit 114.

If the digital video signal is input from the video signal format converting unit 113, the video rotating unit 114 temporarily stores the digital video signal in the frame memory 115, and then the process progresses to a step S52. At the step S52, it is judged whether or not the LCD 31 is the longitudinal screen on the basis of the screen rotation signal supplied from the screen rotation detector 43 at the step S12 or S15 of FIG. 11.

At the step S52, it is judged that the screen rotation signal represents the screen rotation ON and the LCD 31 is the longitudinal screen, the process progresses to a step S53. At the step S53, as described above with reference to FIG. 6, the video rotating unit 114 rotates the video signal from the frame memory 115 by 90 degrees in the direction opposite to the rotation direction of the display unit 21 and reads out, and outputs the TV video signal of 768×1024 to the video signal switch 116. And then, the process progresses to a step S54.

In the example shown in FIG. 13, since the display mode is the TV video display mode, the TV video signal from the video signal switch 116 is input to the digital format converting unit 118 through the reduction magnifying unit 117-1. That is, in the video signal switch 116, the TV video signal is selected and output to the reduction magnifying unit 117-1. In this case, however, since the TV video signal is not displayed on the child screen, in the reduction magnifying unit 117-1, the TV video signal is output to the digital format converting unit 118 as it is (768×1024).

If the TV video signal is input from the reduction magnifying unit 117-1, at the step S54, the digital format converting unit 118 adjusts image quality of the input TV video signal (the digital YCbCr signal), converts the adjusted TV video signal into the digital RGB signal, and outputs the converted TV video signal (the digital RGB signal) to the expansion magnifying unit 119-1. And then, the process progresses to a step S55.

If the TV video signal from the digital format converting unit 118 is input, at the step S55, the expansion magnifying unit 119-1 expands the TV video signal of 768×1024 rotated by 90 degrees to the panel resolution size of the LCD 31 (1680×1050) and outputs the expanded TV video signal. And then, the process progresses to a step S59.

However, the video signal rotated by 90 degrees has an aspect ratio different from the panel resolution size of the LCD 31 (1680×1050). Therefore, in this case, the expansion magnifying unit 119-1 expands the TV video signal of 768×1024 to the size (786×1050) according to the short side (1050) of the LCD 31, adds the black video signal to the remaining portion with no information, and outputs the TV video signal to the signal mixing unit 120 as the video signal of the panel resolution size of the LCD 31 (1680×1050).

On the other hand, when it is judged at the step S52 that the screen rotation signal represents the screen rotation OFF and the LCD 31 is the lateral screen, the process progresses to a step S56. At the step S56, the video rotating unit 114 reads out the video signal from the frame memory 115 as it is and outputs the TV video signal of 1024×768 to the video signal switch 116. And then, the process progresses to a step S57.

In the example shown in FIG. 13, since the display mode is the TV video display mode, the TV video signal from the video signal switch 116 is input to the digital format converting unit 118 through the video signal switch 116 and the reduction magnifying unit 117-1.

If the TV video signal is input from the reduction magnifying unit 117-1, at the step S57, the digital format converting unit 118 adjusts image quality of the input TV video signal (the digital YCbCr signal), converts the input TV video signal into the digital RGB signal, and outputs the converted TV video signal (the digital RGB signal) to the expansion magnifying unit 119-1. And then, the process progresses to a step S58.

If the TV video signal from the digital format converting unit 118 is input, at the step S58, the expansion magnifying unit 119-1 expands the TV video signal of 1024×768 to the panel resolution size of the LCD 31 (1680×1050) and outputs the expanded TV video signal to the signal mixing unit 120 as the video signal of the panel resolution size of the LCD 31 (1680×1050). And then, the process progresses to a step S59.

If the TV video signal from the expansion magnifying unit 119-1 is input, at the step S59, the signal mixing unit 120 converts the input video signal into the signal of the TTL system and outputs the signal of the TTL system to the digital format converting unit 121. And then, the process progresses to a step S60.

At the step S60, the digital format converting unit 121 converts the video signal of the TTL system input from the signal mixing unit 120 into the format corresponding to the LCD 31, such as LVDS, TMDS, or RSDS (Registered Trademark) and outputs the converted video signal to the LCD 31. And then, the video signal processing ends.

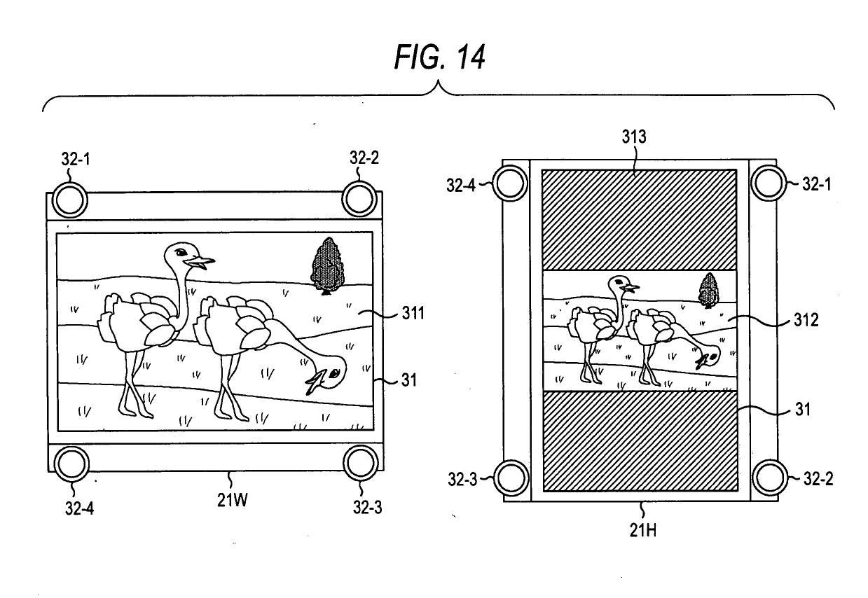

Accordingly, the video corresponding to the TV video signal of the broadcast signal received by the tuner 111 is displayed onto the LCD 31, as shown in FIG. 14.

FIG. 14 shows a display example of the video corresponding to the TV video signal displayed onto the LCD 31 of the display unit 21. In the example shown in FIG. 14, the display unit 21W of the lateral screen and the display unit 21H of the longitudinal screen described with reference to FIG. 5 are shown. The same parts as those in FIG. 5 are represented by the same reference numerals, and the descriptions thereof will be omitted.

In the example shown in FIG. 14, a video 311 corresponding to a TV video signal which is received by the tuner 111 when it is judged that the LCD 31 is the lateral screen at the step S52 of FIG. 13 is displayed onto the LCD 31 of the display unit 21W of the lateral screen.

The video 311 is displayed to have the size according to the panel resolution size of the LCD 31 in the display unit 21W of the lateral screen in a state where the upper part erects upward in the drawing.

That is, when it is judged that the LCD 31 is the lateral screen at the step S52 of FIG. 13, the TV video signal is read out from the frame memory 155 as it is (1024×768) by the video rotating unit 114 and is supplied to the expansion magnifying unit 119-1 through the video signal switch 116, the reduction magnifying unit 117-1, and the digital format converting unit 118.

Since the TV video signal of 1024×768 is expanded to the panel resolution size of the LCD 31 (1680×1050) by the expansion magnifying unit 119-1, the video 311 having the size according to the panel resolution size of the LCD 31 is displayed onto the LCD 31 of the display unit 21W of the lateral screen.

On the other hand, a video 312 corresponding to a TV video signal when it is judged that the LCD 31 is the longitudinal screen at the step S52 of FIG. 13 is displayed onto the LCD 31 of the display unit 21H of the longitudinal screen.

The video 312 is displayed to have the size according to the horizontal direction in the drawing (that is, the short side) of the LCD 31 in the display unit 21H of the longitudinal screen in a state where the upper part erects upward in the drawing. A black video 313 is displayed in a region of the LCD 31 onto which the video 312 is not displayed.

That is, when it is judged that the LCD 31 is the longitudinal screen at the step S52 of FIG. 13, the TV video signal is read out from the frame memory 155 by the video rotating unit 114 to have the size rotated by 90 degrees (768×1024) and is supplied to the expansion magnifying unit 119-1 through the video signal switch 116, the reduction magnifying unit 117-1, and the digital format converting unit 118.

The TV video signal of 768×1024 is expanded to the size (786×1050) according to the short side of the LCD 31 by the expansion magnifying unit 119-1, and the black video signal is added to the remaining portion with no information. And then, the TV video signal is output as the video signal of the panel resolution size of the LCD 31 (1680×1050). As a result, the video 312 having the size according to the short side of the LCD 31 is displayed onto the LCD 31 of the display unit 21H of the longitudinal screen. Onto the LCD 31 other than the video 312, the black video 313 is displayed.

As such, the video signal is read out by rotating the directions of the scan lines of the video signal of the broadcast signal received from the broadcast station according to the rotation of the display unit 21 (the screen direction where the LCD 31 is installed). Therefore, even when the display unit 21 rotates by 90 degrees in the clockwise direction and the screen direction of the LCD 31 is changed from the lateral screen to the longitudinal screen or vice versa, the video of the LCD 31 can be constantly displayed in the erect state while laying the installation surface down.

Further, like the TV video display mode, when the video signal is displayed on the full screen of the LCD 31, the video signal is expanded according to the rotation of the display unit 21 (the screen direction where the LCD 31 is installed). Therefore, even when the screen direction of the LCD 31 is changed from the lateral screen to the longitudinal screen or vice versa, it is possible to provide a comfortable video viewing environment to the user without leaving the video outside the size of the LCD 31.

Next, an example of the signal generation processing of the PC 12 will be described with reference to a flowchart of FIG. 15.

If the power button (not shown) is operated by the user, power is supplied to the individual parts of the PC 12. If power is supplied, the CPU 211 loads a predetermined program (for example, the OS or the signal generation processing program) stored in the storage unit 218 on the RAM 213 and executes the program. Accordingly, the functional blocks shown in FIG. 9 are implemented.

Just after activation, the signal generation control unit 251 controls the display information acquiring unit 252 to request the display device 11 for the display device information through the DDC 13. In response to this request, the micro controller 101 of the display device 11 transmits the display device information including the screen rotation information recorded in the memory 102 at the step S14 or S17 of FIG. 11.

Further, if the PC 12 is on activation, at the step S13 or S16 of FIG. 11, the screen rotation information is transmitted from the display device 11 through the DDC 13.

If the output interface 217 receives the display device information from the display device 11, at a step S81, the display information acquiring unit 252 acquires the display device information from the output interface 217 and supplies the acquired display device information to the signal generation control unit 251. And then, the process progresses to a step S82.

At the step S82, the signal generation control unit 251 judges whether or not the LCD 31 of the display device 11 is the longitudinal screen on the basis of the screen rotation information of the display device information. If it is judged that the LCD 31 of the display device 11 is the longitudinal screen, the process progresses to a step S83. At the step S83, the signal generation control unit 251 causes the wallpaper data acquiring unit 253 to acquire wallpaper data for the longitudinal screen.

That is, at the step S83, the wallpaper data acquiring unit 253 acquires wallpaper data for the longitudinal screen from the storage unit 218 or the like as wallpaper data set as the wallpaper in the desktop and outputs acquired wallpaper data to the video signal generating unit 254. And then, the process progresses to a step S84.

At the step S84, the video signal generating unit 254 generates the video signal for the longitudinal screen according to the control from the signal generation control unit 251. And then, the process progresses to a step S87.

Specifically, the video signal generating unit 254 generates desktop screen data for the longitudinal screen and synthesizes wallpaper data acquired by the wallpaper data acquiring unit 253 or video data generated by another program on activation to generated desktop screen data. And then, the video signal generating unit 254 converts video data into the video signal according to the display format or resolution of the display device 11 (for example, the digital RGB signal of VGA or SXGA+size), and outputs the converted video signal to the signal transmitting unit 256.

On the other hand, when it is judged that the LCD 31 of the display device 11 is not the longitudinal screen, that is, the LCD 31 of the display device 11 is the lateral screen, the process progresses to a step S85. At the step S85, the signal generation control unit 251 causes the wallpaper acquiring unit 253 to acquire wallpaper data for the lateral screen.

That is, at the step S85, the wallpaper data acquiring unit 253 acquires wallpaper data for the lateral screen from the storage unit 218 or the like as wallpaper data set as the wallpaper in the desktop and outputs acquired wallpaper data to the video signal generating unit 254. And then, the process progresses to a step S86.

At the step S86, the video signal generating unit 254 generates the video signal for the lateral screen according to the control from the signal generation control unit 251, and then the process progresses to a step S87.

Specifically, the video signal generating unit 254 generates desktop screen data for the lateral screen and synthesizes wallpaper data acquired by the wallpaper data acquiring unit 253 or video data generated by another program on activation to generated desktop screen data. And then, the video signal generating unit 254 converts video data into the video signal according to the display format or resolution of the display device 11 and outputs the converted video signal to the signal transmitting unit 256.

If the video signal is input from the video signal generating unit 254, at the step S87, the signal transmitting unit 256 transmits the video signal to the display device 11 through the output interface 217 and the DDC 13, if necessary, together with the sound signal input from the sound signal generating unit 255. And then, the signal generation processing ends.

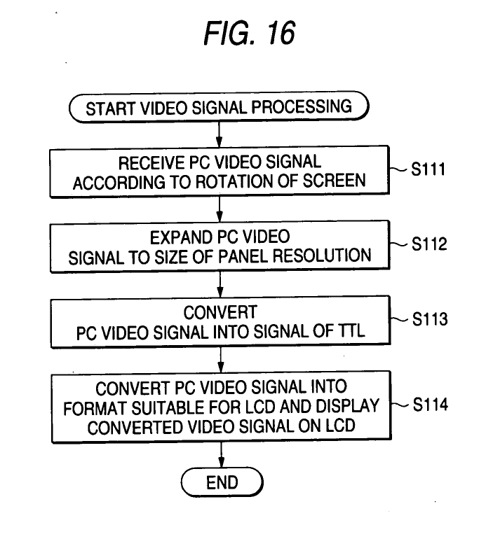

Accordingly, in the display device 11, as described below with reference to FIG. 16, the video is displayed erect onto the LCD 31 of the display unit 21W of the lateral screen or the display unit 21H of the longitudinal screen shown in FIG. 10 according to the video signal from the PC 12. Further, as described above with reference to FIG. 12, predetermined sound is output from the speakers 32-1 to 32-4 according to the sound signal from the PC 12.

Next, an example of a video signal processing of the display device 11 will be described with reference to a flowchart of FIG. 16. Moreover, in FIG. 16, as an example, the PC video display mode where the video of the PC video signal is displayed and sound of the PC sound signal is output in the display device 11 is set.

At the step S87 of FIG. 15, the PC video signal (for example, the digital RGB signal of the 640×480 (VGA) size) according to the screen rotation information (the screen direction of the LCD 31) is transmitted from the PC 12.

At a step S111, the video signal switch 116 receives the PC video signal according to the screen rotation information through the communication interface 104 and outputs the PC video signal to the reduction magnifying unit 117-2. And then, the process progresses to a step S112.

In the example shown in FIG. 16, since the display mode is the PC video display mode, the PC video signal from the video signal switch 116 is input to the expansion magnifying unit 119-2 through the reduction magnifying unit 117-2. That is, in the video signal switch 116, the PC video signal is selected and output to the reduction magnifying unit 117-2. In this case, however, since the PC video signal is not displayed on the child screen, in the reduction magnifying unit 117-2, the PC video signal is output to the expansion magnifying unit 119-2 as it is (640×480).

At the step S112, the expansion magnifying unit 119-2 expands the PC video signal of 640×480 size to the panel resolution of the LCD 31 (1680×1050) and outputs the expanded PC video signal to the signal mixing unit 120 as the video signal of 1680×1050 size. And then, the process progresses to a step S113.

If the PC video signal from the expansion magnifying unit 119-2 is input, at the step S113, the signal mixing unit 120 converts the input video signal into the signal of the TTL system and outputs the signal of the TTL system to the digital format converting unit 121. And then, the process progresses to a step S114.

At the step S114, the digital format converting unit 121 converts the video signal of the TTL system input from the signal mixing unit 120 into the format corresponding to the LCD 31, such as LVDS, TMDS, or RSDS (Registered Trademark), and outputs the converted video signal to the LCD 31. And then, the video signal processing ends.

As such, even when the display unit 21 is in the default state and the LCD 31 is installed as the lateral screen or even when the display unit 21 rotates by 90 degrees from the default state and the LCD 31 is installed as the longitudinal screen, as described above with reference to FIG. 10, the video corresponding to the PC video signal generated and transmitted according to the screen rotation information by the PC 12 is displayed in the erect state onto the LCD 31.

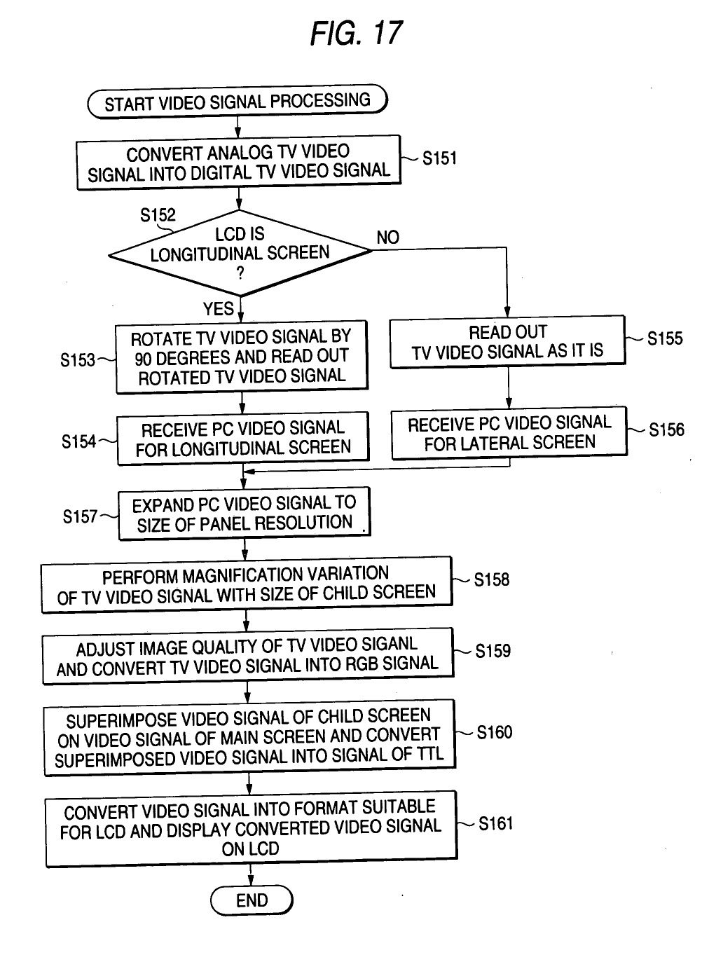

Next, an example of a video signal processing of the display device 11 will be described with reference to a flowchart of FIG. 17. Moreover, in FIG. 17, as an example, the W screen display mode where the video of the TV video signal is displayed on the video of the PC video signal as the child screen is set.

In the display device 11, the antenna (not shown) receives the broadcast signal from the broadcast station (not shown) and outputs the broadcast signal to the tuner 111 as the RF signal. The tuner 111 selects a signal of a predetermined broadcast station among the RF signals from the antenna, converts the selected RF signal into the analog VIF/SIF signal, that is, the video intermediate frequency signal and the sound intermediate frequency signal, demodulates the converted signal to the baseband signal, and outputs the baseband signal to the decoder 112.

The decoder 112 decodes the video signal from the baseband signal of the video signal and the sound signal and outputs the analog TV video signal to the video signal format converting unit 113.

If the analog TV video signal is input from the decoder 112, at a step S151, the video signal format converting unit 113 converts the analog TV video signal into the digital video signal. That is, the video signal format converting unit 113 converts the analog YC signal of 480i from the decoder 112 into the digital YCbCr signal of 1024×768p and the converted digital YCbCr signal to the video rotating unit 114.

If the digital video signal is input from the video signal format converting unit 113, the video rotating unit 114 temporarily stores the digital video signal in the frame memory 115. At a step S152, the video rotating unit 114 judges whether or not the LCD 31 is the longitudinal screen on the basis of the screen rotation signal supplied from the screen rotation detector 43 at the step S12 or S15 of FIG. 11.

At the step S152, when it is judged that the screen rotation signal represents the screen rotation ON and the LCD 31 is the longitudinal screen, the process progresses to a step S153. At the step S153, as described above with reference to FIG. 6, the video rotating unit 114 rotates the video signal from the frame memory 115 by 90 degrees, reads out the TV video signal, and outputs the TV video signal of 768×1024 to the video signal switch 116. And then, the process progresses to a step S154.

At the step S154, the video signal switch 116 receives the TV video signal from the video rotating unit 114 and also receives the PC video signal (for example, the digital RGB signal of 640×480 (VGA) size) for the longitudinal screen (that is, according to the screen rotation information indicating the screen rotation ON) through the communication interface 104. The video signal switch 116 supplies the TV video signal to the reduction magnifying unit 117-1 and inputs the PC video signal to the expansion magnifying unit 119-2 through the reduction magnifying unit 117-2. And then, the process progresses to a step S157.

On the other hand, when it is judged at the step S152 that the screen rotation signal represents the screen rotation OFF and the LCD 31 is the lateral screen, the process progresses to a step S155. At the step S155, the video rotating unit 114 reads out the video signal from the frame memory 115 as it is and outputs the TV video signal of 1024×768 to the video signal switch 116. And then, the process progresses to a step S156.

At the step S156, the video signal switch 116 receives the TV video signal from the video rotating unit 114 and also receives the PC video signal for the lateral screen (that is, according to the screen rotation information indicating the screen rotation OFF) through the communication interface 104. The video signal switch 116 supplies the TV video signal to the reduction magnifying unit 117-1 and inputs the PC video signal to the expansion magnifying unit 119-2 through the reduction magnifying unit 117-2. And then, the process progresses to the step S157.

If the PC video signal is input from the reduction magnifying unit 117-2, at the step S157, the expansion magnifying unit 119-2 expands the PC video signal of 640×480 size to the panel resolution of the LCD 31 (1680×1050) (that is, the size of the main screen) and outputs the expanded PC video signal to the signal mixing unit 120 as the video signal of 1680×1050 size. And then, the process progresses to a step S158.

If the TV video signal is input from the video signal switch 116, at the step S158, since the display mode is the W screen display mode and the TV video signal is displayed on the child screen, the reduction magnifying unit 117-1 reduces the TV video signal input from the video signal switch 116 to the size of the child screen assigned according to the screen rotation ON or OFF in the display device 11 and outputs the reduced TV video signal to the digital format converting unit 118. And then, the process progresses to a step S159.

Specifically, when the screen rotation is not in the ON state (the screen rotation is in the OFF state), the video signal of 1024×768 is input, and thus the reduction magnifying unit 117-1 reduces the video signal to the size of the child screen (320×240) and outputs the reduced video signal. Further, when the screen rotation is in the ON state, the video signal of 768×1024 is input, and the reduction magnifying unit 117-1 reduces the video signal to the size of the child screen (240×320) and outputs the reduced video signal.

If the TV video signal is input from the reduction magnifying unit 117-1, at the step S159, the digital format converting unit 118 adjusts image quality of the input TV video signal (the digital YCbCr signal), converts the TV video signal into the digital RGB signal, and outputs the converted TV video signal (the digital RGB signal) to the expansion magnifying unit 119-1. And then, the process progresses to a step S160.

In the example shown in FIG. 17, since the TV video signal is displayed on the child screen, the TV video signal input to the expansion magnifying unit 119-1 is output to the signal mixing unit 120 as it is.

If the TV video signal from the digital format converting unit 118 and the PC video signal from the video signal switch 116 are input, at the step S160, the signal mixing unit 120 superimposes the TV video signal of the child screen (320×240 or 240×320) on the PC video signal of the main screen (1680×1050), converts the superimposed video signal into the signal of the TTL system, and outputs the signal of the TTL system to the digital format converting unit 121. And then, the process progresses to a step S161.

At the step S161, the digital format converting unit 121 converts the video signal of the TTL system input from the signal mixing unit 120 into the format corresponding to the LCD 31, such as LVDS, TMDS, or RSDS (Registered Trademark) and outputs the converted video signal to the LCD 31. And then, the video signal processing ends.

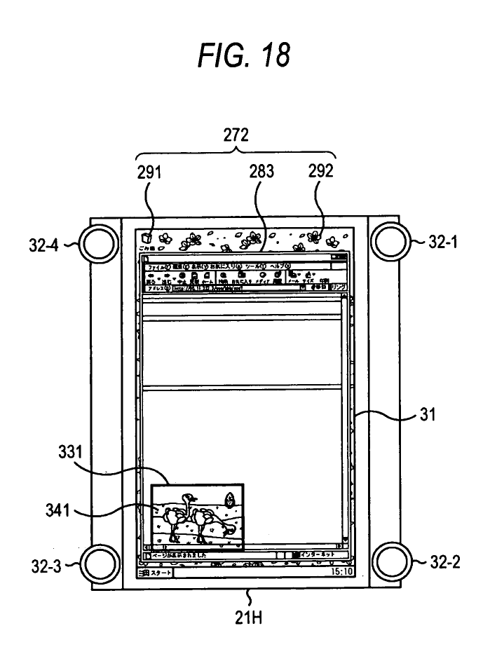

Accordingly, the video corresponding to the PC video signal and the TV video signal is displayed onto the LCD 31, as shown in FIG. 18.

FIG. 18 shows a display example of the video corresponding to the PC video signal and the TV video signal displayed onto the LCD 31 of the display unit 21.

In the example shown in FIG. 18, there is shown the display unit 21H of the longitudinal screen where the video 272 corresponding to the PC video signal is displayed onto the LCD 31, as described with reference to FIG. 10. The same parts as those in FIG. 10 are represented by the same reference numerals, and the descriptions thereof will be omitted.

That is, onto the LCD 31 of the display unit 21H of the longitudinal screen, the video 272 which corresponds to the generated video signal in the PC 12 and has the desktop video 291 for the longitudinal screen, such as icons or a menu bar, the cherry-like wallpaper 292 for the longitudinal screen, and the application window 283 is displayed in the erect state to have the size according to the panel resolution of the LCD 31 (that is, the entire LCD 31) as the main screen of the W screen display mode.

In the example shown in FIG. 18, a video 341 which corresponds to the TV video signal rotated by 90 degrees by the video rotating unit 114, read out from the frame memory 115 as the video signal of 768×1024, and reduced to the size of the child screen (240×320) by the reduction magnifying unit 117-1 is displayed in the erect state on a child screen 331 of the W screen display mode superimposed on the video 272.

Moreover, though not described, as for the display unit 21W of the lateral screen, the video corresponding to the PC video signal is displayed in the erect state on the main screen and the video corresponding to the TV video signal is displayed in the erect state on the child screen.

Further, although the video corresponding to the PC video signal is displayed on the main screen and the video corresponding to the TV video signal is displayed on the child screen in the examples shown in FIGS. 17 and 18, the video corresponding to the TV video signal may be displayed on the main screen and the video corresponding to the PC video signal may be displayed on the child screen.

As such, the video signal is read out by rotating the directions of the scan lines of the video signal of the broadcast signal received from the broadcast station according to the rotation of the display unit 21 (the screen direction where the LCD 31 is installed) Further, the screen rotation information is transmitted to the Pc 12, and then the PC video signal according to the rotation of the display unit 21 is generated from the PC 12.

Therefore, even when the display unit 21 rotates by 90 degrees in the clockwise direction or the counterclockwise direction and the screen direction of the LCD 31 is changed from the lateral screen to the longitudinal screen or vice versa, the video of the LCD 31 displayed according to the TV video signal and the PC video signal can be constantly displayed in the erect state while laying the installation surface down.

Further, according to the display device 11 of the present embodiment, when the screen installation direction is changed, a real stereo sound field (virtual speaker position) can be simply implemented and a real stereo sound field can be provided to the user. Further, according to the display device 11 of the present embodiment, even when the screen installation direction is changed, the video can be simply displayed in the erect state on the screen.

That is, according to the display device 11 of the present embodiment, even when the screen installation direction is changed, a comfortable viewing environment for the video and sound can be provided to the user.

Moreover, although the speakers 32-1 to 32-4 are provided at the four corners of the display unit 21 in the display device 11 described above, what is necessary is that the amplification factor of the sound output amplifier 134 is set so as to generate the sound field at a desired position (for example, the central portion of the LCD 31), and thus the speakers may be provided at symmetrical position in the horizontal direction or the vertical direction with respect to a predetermined position, as well as to the central portion of the LCD 31 (that is, the speakers may not be provided at symmetrical positions with respect to the central portion).

Further, although the four speakers are provided in the display device 11, four speakers or more, for example, six or eight speakers may be provided. Further, although the stereo sound signal is described, the present invention can be similarly applied to a sound signal having a large number of channels.

In addition, in the display device 11 described above, in the sound output amplifier 134 at the back of the channel matrix switch 133, the amplification factor of the sound signal is adjusted. Alternatively, the amplification factor of the sound signal may be adjusted by the stereo preamplifier 132 in front of the channel matrix switch 133 or the like. Further, the adjustment method is not limited to the above-described method.

Moreover, although the display device 11 having the built-in tuner is used as a display unit of the PC 12, the present invention can be applied to a broadcast signal receiving device, a personal computer, a cellular phone, other PDA (Personal Digital Assistant) apparatus, or a CE (Consumer Electronics) apparatus, such as an AV (Audio Visual) apparatus or an appliance as long as it has a display unit and at least four speakers.

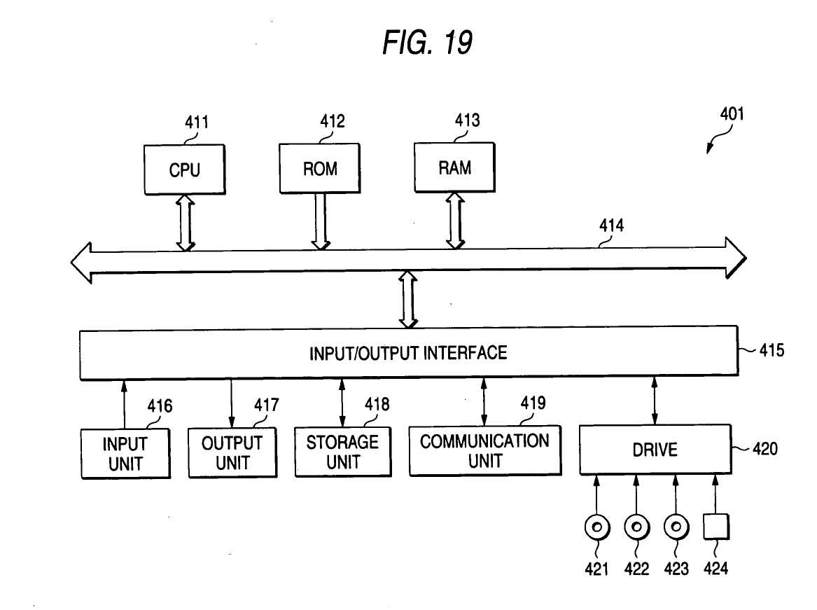

A series of processing can be executed by hardware, but can be executed by software. In this case, for example, the display device 11 shown in FIG. 1 has a personal computer 401 shown in FIG. 19.

In FIG. 19, a CPU (Central Processing Unit) 411 executes various kinds of processing according to a program stored in a ROM (Read Only Memory) 412 or a program loaded on a RAM (Random Access Memory) 413 from a storage unit 418. The RAM 413 also stores data required to allow the CPU 411 to execute various kinds of processing.

The CPU 411, the ROM 412, and the RAM 413 are connected to one another trough a bus 414. Further, an input/output interface 415 is also connected to the bus 414.

An input unit 416 having a keyboard or a mouse, an output unit 417 having a display, such as a CRT (Cathode Ray Tube) or an LCD (Liquid Crystal Display), and a speaker, a storage unit 418 having a hard disk, and a communication unit 419 having a modem or a terminal adapter are also connected to the input/output interface 415. The communication unit 419 performs communication processing through a network, such as wireless or the like.

If necessary, a drive 420 is connected to the input/output interface 415, and a magnetic disk 421, an optical disk 422, a magneto-optical disk 423, and a semiconductor memory 424 are properly mounted on the drive 420. If necessary, a computer program read out from the disk is installed in the storage unit 418.

When a series of processing is executed by software, a program constituting software is installed from the network or the recording medium, for example, in a computer which is incorporated in dedicated hardware or a general-use personal computer which can execute various functions by installing various programs.

Moreover, the program is not particularly limited as long as it can execute a series of processing described above as a whole. For example, a module configuration which has modules corresponding to the blocks described above may be used. Further, a module configuration which has a module incorporating some or all of the functions of the blocks or modules with the functions of the blocks divided therein may be used. Alternatively, a program having only one algorithm may be used.

As shown in FIG. 19, the recording medium may be package media which is distributed to provide the program to the user separately from the apparatus main body, such as the magnetic disk 421 (including a flexible disk), the optical disk 422 (including CD-ROM (Compact Disk-Read Only Memory) and DVD (Digital Versatile Disk)), the magneto-optical disk 423 (including MD (Mini-Disk) (Trademark)), or the semiconductor memory 424, which has a program recorded therein. Further, the recording medium may be the ROM 412 recorded with a program or a hard disk included in the storage unit 418, which is provided to the user while being incorporated in the apparatus main body in advance.

In this specification, the steps which describe a program for causing a computer to execute various kinds of processing are not necessarily processed in time series according to the sequence described in the flowchart. A processing which executes the steps in parallel or individually (for example, parallel processing or processing by objects) may be included.

Further, the program may be processed by a single computer or may be processed by a plurality of computers by a distributed processing. In addition, the program may be transferred to a remote computer to be then executed.

Moreover, in this specification, the system means the whole apparatus comprising a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus which performs control to display images, the information processing apparatus comprising:
a display unit which has a display surface to display the images;
at least four speakers which are disposed in the periphery of the display surface on the display unit;
a rotation detecting unit which detects a 90 degree rotation of the display unit on a predetermined position of the display unit; and
a switching unit which switches left and right outputs of a pair of speakers at diagonal positions of the four speakers according to the 90 degree rotation of the display unit detected by the rotation detecting unit.

2. The information processing apparatus according to claim 1, further comprising:
a support unit which rotatably supports the display unit on the predetermined position of the display unit.

3. The information processing apparatus according to claim 1, further comprising:
an output adjusting unit which adjusts output gains of the four speakers according to the 90 degree rotation of the display unit detected by the rotation detecting unit.

4. The information processing apparatus according to claim 1, further comprising:
a signal receiving unit which receives a broadcast signal;
a video rotating unit which rotates a video signal of the broadcast signal received by the signal receiving unit according to the 90 degree rotation of the display unit detected by the rotation detecting unit; and
a display control unit which performs control to display a video corresponding to the video signal rotated by the video rotating unit onto the display surface.

5. The information processing apparatus according to claim 4, further comprising:
a video magnifying unit which magnifies the video signal rotated by the video rotating unit according to an image frame of the display unit whose 90 degree rotation is detected by the rotation detecting unit,
wherein the display control unit performs control to display the video corresponding to the video signal magnified by the video magnifying unit onto the display surface.

6. The information processing apparatus according to claim 4, further comprising:
a transmitting unit which transmits information of the 90 degree rotation of the display unit detected by the rotation detecting unit to another information processing apparatus; and
a superimposing unit which superimposes the video signal rotated by the video rotating unit on a video signal from another information processing apparatus,
wherein the display control unit performs control to display the video corresponding to a superimposed video signal by the superimposing unit onto the display surface.

7. An information processing method of the information processing apparatus which performs control to display images, the information processing method comprising the steps of:
detecting a 90 degree rotation of a display unit having a display surface to display the images on a predetermined position of the display unit; and
switching left and right outputs of a pair of speakers at diagonal positions of at least four speakers disposed in the periphery of the display surface on the display unit according to the 90 degree rotation of the display unit detected by a processing at the rotation detecting step.

8. A recording medium which records a program for causing a computer to execute a processing for performing control to display images, the program comprising the steps of:
detecting a 90 degree rotation of a display unit having a display surface to display the images on a predetermined position of the display unit; and
switching left and right outputs of a pair of speakers at diagonal positions of at least four speakers disposed in the periphery of the display surface on the display unit according to the 90 degree rotation of the display unit detected by a processing at the rotation detecting step.

9. A program which causes a computer to execute a processing of performing control to display images, the program comprising the steps of:
detecting a 90 degree rotation of a display unit having a display surface to display the images on a predetermined position of the display unit; and
switching left and right outputs of a pair of speakers at diagonal positions of at least four speakers disposed in the periphery of the display surface on the display unit according to the 90 degree rotation of the display unit detected by a processing at the rotation detecting step.
